(19) United States
(12) Patent Application Publication
(10) Pub. No.: US 2017/0374070 A1
(43) Pub. Date: Dec. 28, 2017

(54) SCALABLE POLICY BASED EXECUTION OF MULTI-FACTOR AUTHENTICATION

(71) Applicant: INTERDIGITAL TECHNOLOGY CORPORATION, Wilmington, DE (US)

(72) Inventors: Yogendra C. SHAH, Exton, PA (US); Li-Hsiang SUN, Smithtown, NY (US); Nobuyuki TAMAKI, Melville, NY (US); Vinod Kumar CHOY, Conshohocken, PA (US); Rafael A. CEPEDA, London (GB)

(21) Appl. No.: 15/542,250

(22) PCT Filed: Jan. 8, 2016
(86) PCT No.: PCT/US2016/012645

§ 371 Date: Jul. 7, 2017

Related U.S. Application Data
(60) Provisional application No. 62/101,677, filed on Jan. 9, 2015.

(51) Int. Cl. H04L 29/06

(52) U.S. Cl. CPC H04L 63/0884; H04L 63/20; H04L 2463/082

(57) ABSTRACT

Current approaches to multi-factor authentication lack scalability, among other capabilities and efficiencies. Described herein are methods, devices, and systems that provide for robust and scalable multi-factor authentication using a combination of network-based and device-based authentications. In an example embodiment, a common policy framework enables policy enforcements to be carried out in the network or on the device. As described below, the framework may provide synchronization of policies and authentication results between a network entity and an entity on a user device.

### CROSS REFERENCE TO RELATED APPLICATIONS

This Application claims the benefit of U.S. Provisional Application Ser. No. 62/101,677, filed Jan. 9, 2015, the disclosure of which is hereby incorporated by reference as if set forth in its entirety herein.

### BACKGROUND

Authentication is classically divided into four distinct categories: 1) something you are, which may be any kind of biometric authentication involving identification of biological characteristics; 2) something you do, which may be any kind of behavior based authentication involving identification of behavioral characteristics; 3) something you know, which relies on information from a user's memory; and 4) something you possess, which typically extends protection by verifying that an individual has possession of some physical element, such as a key fob, for example. From a technical perspective, lifecycle management and operational processing of authentication credentials can differ for each category. From a security perspective, the authentication strengths of each category may vary.

Multi-factor authentication (MFA) is a relatively new approach to user authentication security, stemming from the inadequacy of purely password-based authentication. Much of current MFA efforts involve the use of multiple steps for user authentication. For example, when conducting a payment transaction, a user may be asked to input a personal identification number (PIN) in order to access a user's smart card. In this example, even though on the surface it may appear to be authentication using multiple factors, it is not truly MFA because the PIN is tied to the smart card and does not exist independently of the “something you possess.” Other authentication mechanisms implement multi-factor authentication by using a static combination of two of the factor categories mentioned above. Current approaches to multi-factor authentication lack scalability and usability, among other capabilities and efficiencies.

### SUMMARY

Described herein are methods, devices, and systems that provide for robust and scalable multi-factor authentication using a combination of network-based and device-based authentications. In an example embodiment, a common policy framework enables policy enforcements to be carried out in the network or on the device. As described below, the framework may provide synchronization of policies and authentication results between a network entity and an entity on a user device.

In an example embodiment, an authentication server (AS), for instance a multi-factor authentication server (MFAS) maintains at least one database, such that the at least one database comprises user profile information related to a plurality of users, authentication information related to a plurality of user devices, and policy information related to a plurality of service providers. The MFAS may receive an authentication request from a first service provider of the plurality of service providers. In response to the authentication request, the MFAS may obtain information from the at least one database to authenticate a first user of the plurality of users in accordance with the policy information related to the first service provider. The policy information may indicate an assurance level that is required by the first service provider, such that the first user is authenticated to a level that is sufficient as compared to the assurance level required by the first service provider. Further, the at least one database may include a user database for maintaining the user profile information related to the plurality of users, a user equipment database for maintaining the authentication information related to the plurality of user devices, and a service provider database for maintaining the policy information related to the plurality of service providers.

### BRIEF DESCRIPTION OF THE DRAWINGS

A more detailed understanding may be had from the following description, given by way of example in conjunction with the accompanying drawings, wherein:

FIG. 1 is a block diagram of a multi-factor authentication server (MFAS) system in accordance with an example embodiment;

FIG. 2 is a flow diagram that shows an authentication process using the MFAS in accordance with an example embodiment;

FIG. 3 is a block diagram that shows architectural components and interfaces of the MFAS in accordance with an example embodiment;

FIG. 4 is a block diagram that shows architectural components and interfaces of a multi-factor authentication proxy (MFAP) that is on a user device in accordance with an example embodiment;

FIG. 5 is a call flows that shows authentication phases between a user, the MFAP, and the MFAS in accordance with an example;

FIG. 6 shows an example process for key generation;

FIG. 7 is a call flow illustrating a configuration of a policy framework in accordance with an example embodiment;

FIG. 8 is an example outline of various databases used in the MFAS in accordance with an example embodiment;

FIG. 9 is an example of a service provider authentication factors record;

FIG. 10 is an example of a service provider device record;

FIG. 11 is an example of a service provider device specific factors record;

FIG. 12 is an example of user device supported factors record;

FIG. 13 is an example of a user session record;

FIG. 14 is a diagram illustrating MFAS policy management in accordance with an example embodiment, wherein a freshness of each authentication factor is assessed;

FIG. 15 is a diagram that shows example inputs and outputs for an example authentication factor;

FIG. 16 is a call flow that shows an example of a successful multi-factor authentication executed by the MFAS and MFAP in accordance with an example embodiment;

FIG. 17A is a system diagram of an example communications system in which one or more disclosed embodiments may be implemented;

FIG. 17B is a system diagram of an example wireless transmit/receive unit (WTRU) that may be used within the communications system illustrated in FIG. 17A; and

FIG. 17C is a system diagram of an example radio access network and an example core network that may be used within the communications system illustrated in FIG. 17A.

### DETAILED DESCRIPTION OF ILLUSTRATIVE EMBODIMENTS

As mobile users demand access to a wide range of applications and services that have varying degrees of security requirements, it has become difficult for service providers (SPs) to provide access to services using only password-based authentication. Stronger forms of authentication, however, can burden users with overly interactive and clumsy procedures, and might lead to users seeking services that require a lower grade of security. Users might also simplify the authentication steps, which may compromise security. It is recognized herein that it can be critical for SPs to tailor their security requirements in accordance with the type of transaction that is requested by the user, in order to unburden the user, without compromising the security. To ensure that only a legitimate user has access to a service or application, a robust authentication framework may be required that incorporates at least some, for instance all, of the specific factors of authentication that are available to a given user. The variety and number of authentication factors, together with new authentication features that are developed, can lead to complex requirements for the user device for a given SP. In order for an SP to implement a coherent set of policies, standards, protocols, and software/hardware resources for multi-factor authentication, immense resources may be required at the SP. Further, authentication capabilities at the SP might require a corresponding set of capabilities on the user devices. Further still, each SP may have a different set of requirements that then have to be matched to the unique capabilities of each user device. Thus, it is recognized herein that the security measures implemented for authentication should be robust, adaptive, risk-based, and transparent or friction free to users, and easy to adopt and manage by service providers.

Recently, industry players founded the Fast IDentity Online (FIDO) Alliance, which has a goal of reducing the reliance on passwords for authentication. The FIDO Alliance also aspires to define a scalable and interoperable authentication infrastructure. The architecture and protocol specified by the FIDO Alliance enables the integration of any authentication function, such as an RSA token, a fingerprint reader, or an embedded token (e.g., in a Trusted Execution Environment (TEE)) for example, which is registered to the FIDO infrastructure, such that the authentication function can be used in an authentication to a Web service provider. Although this may provide a unified way to access different factors of authentication, it is recognized herein that no systematic handling of interacting authentication factors is enabled. In this regard, the approach is more of a multi-step single-factor authentication rather than a truly multi-factor authentication. Another limitation recognized herein of the FIDO infrastructure is that the FIDO infrastructure does not operate in a federated manner.

Another issue with existing approaches is that the time validity of authentication may be unclear. Further, other inherent characteristics of authentication factors may be unclear, such that existing solutions cannot scale according to available authentication factors and their characteristics. In some cases, finding the correct combination of authentication factors for a specific purpose requires a detailed analysis of the security capabilities of a user device, followed by the deployment of a tailored authentication. This can become particularly expensive and unscalable (e.g., considering the required lifecycle management) when authentication factors of differing categories are used.

It is recognized herein that assessing characteristics and assigning attributes to different factors of authentication, discovering what factors of authentication a specific user/device is capable of supporting, and performing a multi-factor authentication (e.g., on behalf of service providers) poses challenges to service providers. For example, service providers may wish to have full policy level visibility into the various factors of authentication. In some cases, service providers desire control over how the factors are assessed and combined with each other, on a per user/device level. Because there are a diverse set of devices available on the market, and because new factors of authentication are emerging frequently, service providers may wish to easily access multi-factor authentication (MFA) while maintaining policy level control of a user authentication. By way of example, an iPhone 5s and a Samsung S5 both support fingerprint authentication. The iPhone 5s performs the authentication in a secure environment, and the fingerprint processing is securely handled from capture to authentication. In contrast, the Samsung S5 performs some of the processing in software (SW) on the user device, which therefore may be exposed to potential malware attacks. Hence, continuing with the example, an individual service provider may assess the level of assurance achievable from an iPhone 5s to be higher (e.g., 5) as compared to an assurance level that can be archived by the Samsung S5 (e.g., 4). In some cases, being able to control and manage authentication attributes, for example fingerprint authentication attributes, at a service provider level may be important to a given SP. Furthermore, in an example embodiment, the security of a device or the trustworthiness of a device may be an authentication factor itself. So, for example, if the trust state of the Samsung S5 can be measured, and attestation to the state can be assured, then a service provider may increase the level of assurance of the Samsung S5 to the same level as the iPhone 5s.

Embodiments described herein efficiently implement, at a scale, multiple levels of access control security requirements through the use of multiple factors of authentication. In one embodiment, priorities of authentication factors, which provide ease of access to users, are determined in a local or network-based authentication. In another embodiment, authentication factors are combined to match higher security needs that are not supported by a single instance of an insufficient authentication factor. As further described below, authentication methods (factors) that are supported by a specific user/device combination are discovered, and service provider policy specific information is assigned to those authentication factors. As described herein, authentication of a user is facilitated using a combination of local (to the user device) and network-based authentication methods, in offline (e.g., no network connectivity) or online modes. In another embodiment, service providers can specify policies regarding how different factors of authentication are combined to achieve a specific level of access control security, and regarding how the persistence of any previous authentications should be taken into account. In yet another embodiment, an authentication policy is provisioned on an authentication end point, and local policies are delegated to a local policy agent. Thus, in accordance with various embodiments described herein, efficient authentication policy control, which can be tailored for each SP, can be enabled; user/device authentication records for executing a multi-factor authentication can be dynamically created; authentication factor attributes (down to the specific user device capability) can be easily managed; overall user authentication using multiple factors of authentication can be determined and controlled in a policy based manner; an authentication policy system can be scaled to account for the specific service provider needs, a variety of devices, and various authentication factors; specific authenticator factors supported by a user device can be abstracted; and the required risk based assurance level can be mapped to the specific authentication factors supported by a user device. Unless otherwise specified, the terms service provider (SP) and relying party (RP) can be used interchangeably herein, without limitation.

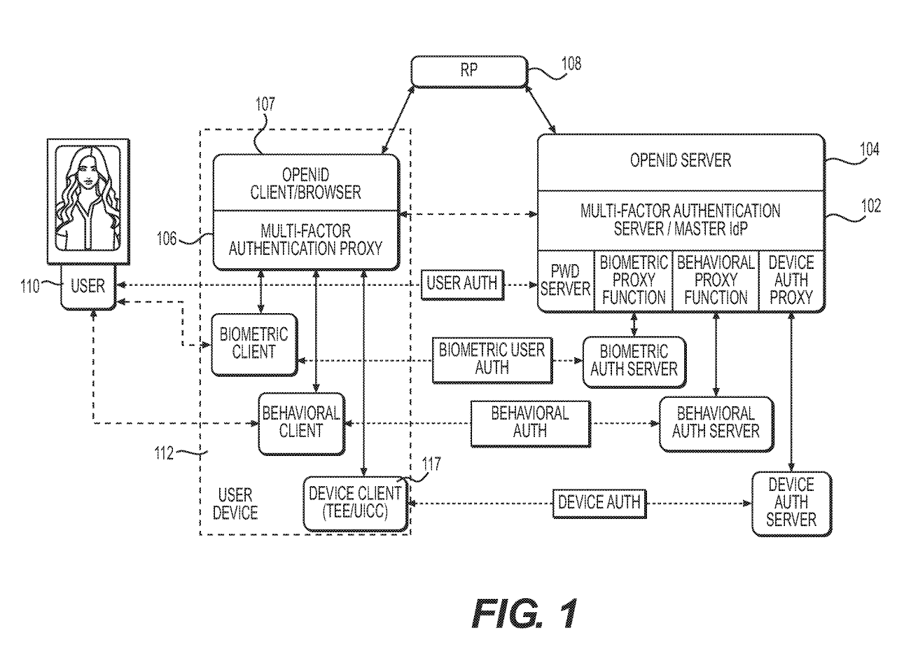

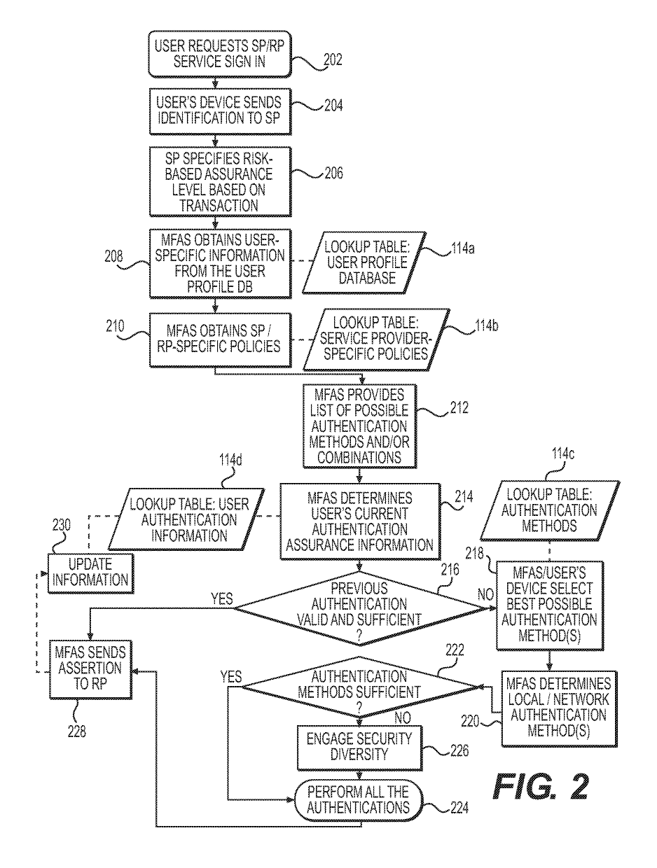

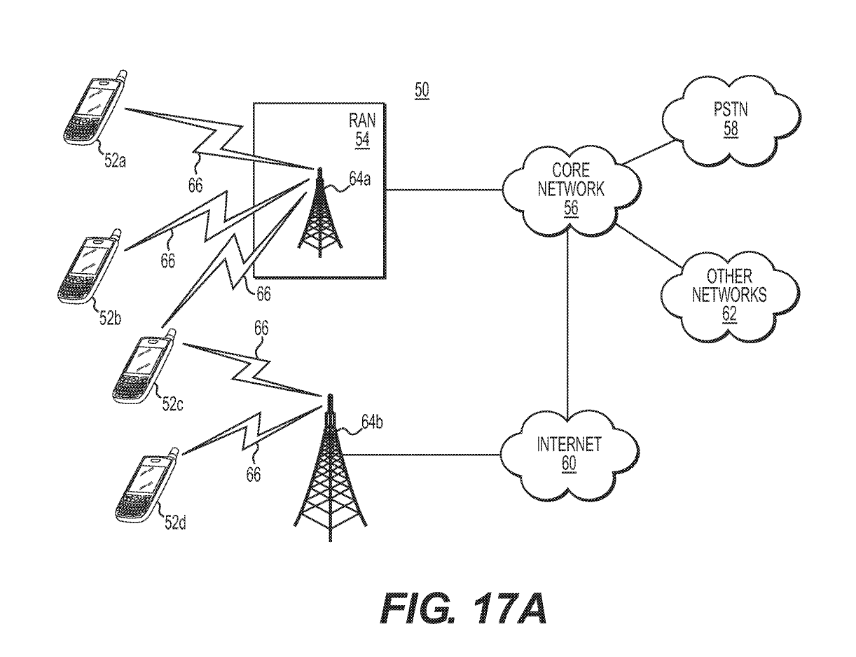

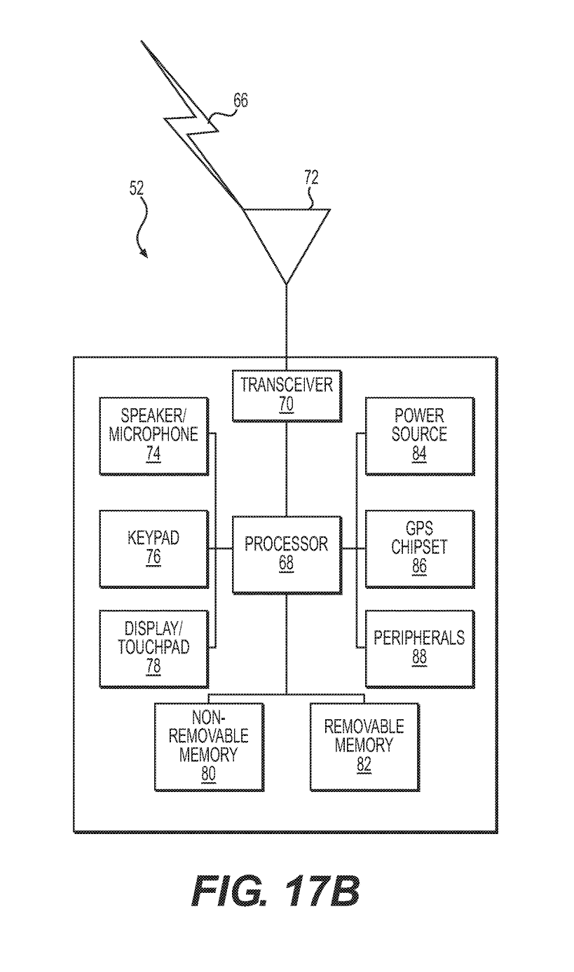

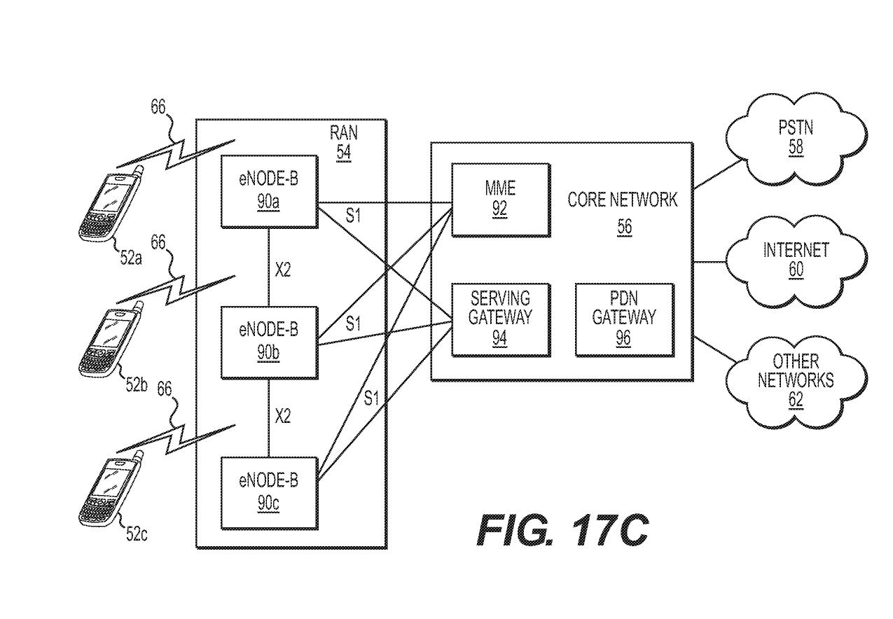

FIGS. 1-16 and the description related thereto illustrate various embodiments of methods and apparatuses related to a policy framework for saleable execution of multi-factor authentication. In these figures, various steps or operations are shown being performed by one or more nodes, devices, functions, or networks. It is understood that the nodes, devices, functions, or networks illustrated in these figures may represent logical entities in a communication network and may be implemented in the form of software (e.g., computer-executable instructions) stored in a memory of, and executing on a processor of, a node of such network, which may comprise one of the general architectures described herein (e.g., see FIGS. 1, 3, and 4). That is, the methods illustrated in FIGS. 2, 5, 7, and 9-16 may be implemented in the form of software (e.g., computer-executable instructions) stored in a memory of a network node, such as for example the node depicted in FIG. 17B, which computer executable instructions, when executed by a processor of the node, perform the steps illustrated in the figures.

Referring now to FIG. 1, authentication can be performed using an authentication server (AS), for instance a multi-factor authentication server (MFAS) 102, in accordance with an example embodiment. The MFAS 102 may perform the role of an orchestrator. For example, the MFAS 102 may select multiple authentication factor servers, based on assurance level requirements from a given service provider. The MFAS 102 may be part of a service provider function. Alternatively, as shown, the MFAS 102 may be implemented in an identity provider function in a federated framework. For example, the MFAS may be implemented as part of the functionality OpenID Server 104, and therefore the MFAS 102 may enable the use of single sign-on credentials using an OpenID identity. It will be appreciated that OpenID is used herein for purposes of example, but embodiments are not limited to using OpenID, and thus the OpenID server 104 can be any identity provider server as desired. The MFAS 102 may operate in a federated or in a non-federated manner. Without restriction, other client-server frameworks (e.g., a FIDO architecture) or federated frameworks (e.g., SAML) are possible. As shown, in accordance with the example embodiment, the MFAS 102 interacts with a Local MFA proxy (MFAP) 106 that resides on a user device 108. The MFAP 106 may function as a proxy to the workings of the MFAS 102.

In accordance with the illustrated embodiment, service providers, for instance a service provider 108, may be provided with an ease of access to MFA through a policy driven authentication framework, where an authentication request is aligned with a risk based assurance level specification. The complexities involved with administering an MFA capability may be hidden behind the service provider 108, for instance at a function of the MFAS 102. The MFAS 102 may perform authentications using authentication factors that correspond to capabilities of each unique instance of a user and a user device combination. It is recognized herein that an OpenID compliant architecture may facilitate adoption by the many service providers that already use OpenID for access control. It will be understood that other identity federation protocols (e.g., OpenID Connect, SAML) may be employed in place of OpenID, though OpenID terms and concepts are often referred to herein for purposes of example. The MFAS 102 can apply flexible policies to combine local and network authentication. Further, in accordance with the illustrated embodiment, users, for instance a user 110 of a user device 112, are provided with an authentication experience that minimizes friction. For example, user access to a service may be seamless when continuous authentication is being performed or when the freshness of a previous authentication is sufficient to meet the requirements of the service provider 108 (authentication persistence). In some cases, privacy of the user 110 is assured by not leaving an identity trail or personal information behind with a given service provider. In one embodiment, Service Provider-specific MFA policies can be incorporated into the MFAS 102.

Referring also to FIG. 2, to mitigate issues related to managing multiple authentication methods in an environment where the devices used for authentication support different or limited authentication capabilities, security needs and authentication factors can be ranked. The policy framework architecture described herein support such rankings. An example method is depicted in FIG. 2 and explained below.

In an example embodiment, a role of the MFAS 102 is to enable transparent access to authentication factors. The authentication factors may be authenticated by third parties that interface with the MFAS 102. The MFAS 102 may selectively invoke the authentication factors, and bind the results of the authentications into an aggregated multi-factor authentication assertion. The MFAS 102 may use authentication factors to perform network-based authentications, network-assisted authentications, local authentications, or combinations thereof.

In an example network-based authentication, the MFAS 102 interacts with an entity in the network, to execute an authentication factor. The entity in the network can be an authentication server. In some cases, MFAS 102 may aid the authentication server in providing an online user interface. For instance, the authentication server may send an authentication page to the user's Web browser, on which the user enters his/her password. The password may be confidentiality protected by hashing with a JavaScript on the webpage, or the password may be transported over a secure channel to the authentication server. The authentication server may match a user credential (e.g., password) against a credential stored at the authentication server. In particular, for example, the user credential may be matched against a credential stored using a Lightweight Directory Access Protocol (LDAP).

In an example network-assisted authentication, the authentication is performed on the network side based on credentials collected on the user device 112. In some cases, a network-assisted authentication requires the direct or indirect interaction of an authentication server with a local authentication entity. The local authentication entity may reside on, or be connected to, the user device 112. An example of a network-assisted authentication is a mobile network authentication that uses the Authentication and Key Agreement (AKA) protocol or the Generic Bootstrapping Architecture (GBA) for authentication toward third party application services. Other examples include smart card or smart (soft or hard) token-based authentications, which may additionally require interaction with an authentication server to verify credentials. Rivest-Shamir-Adleman (RSA) tokens and server-based one time password (OTP) schemes may also be categorized as network-assisted authentications.

In an example local authentication, one or more credentials are verified locally on the user device 112 or on a device that is connected to the user device 112. The results of the local authentication can be exposed so that they can be used by the MFAP 106. An example of a local authentication is the use of a government issued electronic identity document that requires local authentication to a secure reader, for instance, using match-on-card biometrics. A third party service, for example the MFAS 102, may then run a specified protocol with the reader, via the device 112, to obtain and verify the assertion created as an outcome of a local authentication. In some cases, an authentication is considered local when a given authentication factor does not require interaction with the network for a normal authentication operation using the factor. Another example of a local authentication is a continuous authentication in which the user 110 is continuously being authenticated, for example using behavioral characteristics such as keyboard dynamics or facial recognition. A local authentication may also be used for access to local resources on the user device 112 (e.g., via the MFAP 106) without interaction with the MFAS 102.

As described above, the MFAS 102 may have the capability to connect with and use various authentication mechanisms. Thus, in some cases, the functionality of the MFAS 102 may be separated into an MFAS function that resides on a network entity (e.g., OpenID server 104), and a multi-factor authentication proxy (MFAP) function that resides on the user device 112. For example, the MFAS 102 may facilitate execution of an authentication through coordination of network-assisted authentication factors and locally executed authentication factors on the user device 112. An example of a network assisted factor is an authentication using a mobile network authentication protocol, such as GBA or EAP-SIM/EAP-AKA/EAP-AKA′, which can be accessed via the device Radio Interface Layer (RIL) through an API such as the OpenMobileAPl, which enables access to the SIM/UICC from the application layer.

In the language of policy systems, the MFAS 102 may act as a policy decision point (PDP) and a policy enforcement point (PEP). Thus, the MFAS 102 may also be referred to as a PDP/PEP. In some cases, the MFAS 102 controls a policy processing engine, which actively selects an enforceable authentication policy based on an assurance level (AL) that is received from the SP 108. It will be understood that, unless otherwise specified, the terms service provider (SP) and relying party (RP) may be used interchangeably herein, without limitation. Information stored in a policy database may also contain policies that are specified by an SP to control selection and prioritization of authentication factors. In some cases, a database may contain information related to various users and various devices. In an example embodiment, the MFAS 102 maps a given AL to an authentication policy that stipulates an authentication factor that should be performed, or a prioritized list of authentication factors that should be performed, to achieve the AL. This mapping can take into account various conditions, such as, for example and without limitation, contextual information, regulations (from governments or standards bodies), authentication capabilities (of the device or network), and authentication factor attributes (e.g., assurance level). Example contextual information includes, time, date, location, device battery charging state, ambient light, ambient noise, or the like.

In some cases, the MFAS 102 may separate a given policy into a local policy and a network policy. The local policy may be executed by the MFAP 106 for local or network-assisted factors for which the MFAP 106 controls the authentication and receives the result, and the execution of the network policy may be controlled entirely by the MFAS 102. In one example, the MFAS 102 acts as a master by initiating the execution of the relevant policies, both at the network side and the device side. The MFAP 106 may execute local authentication factors in a given sequence that is received as a list from the MFAS 102. This means, in this example, that there is no need for a policy engine at the MFAP 106. In an alternative example, the policy engine at the MFAS 102 dynamically determines a separation of the network side policies (which are handled by the MFAS 102) and local policies (which the MFAP 106 can handle as a proxy policy engine). Thus, there may be separation of duties between the MFAS 102 and the MFAP 106. In some cases, the MFAP 106 might not be directly controlled by the MFAS 102 except for the initial policy push and any subsequent policy updates.

It should be understood that, although an example scenario of a federated authentication is described herein, the concepts and principles described herein may be applied to a collapsed scenario in which, for example, the MFAS functionality and the SP/RP functions are collapsed into a single entity or the same administrative/security domain. By way of example, a bank may wish to have full control of the user authentication process. The architecture described herein enables scenarios in which the MFAS/SP combination acts as both an MFAS and an SP. For example, Facebook or Google may act both as service provider (SP) and an identity provider (IdP). For example, an SP may perform as an IdP to other service providers when the third party service providers allows users to log in with a credential that is associated with an IdP (e.g., Facebook or Google).

In an example embodiment, the mapping of an AL to authentication policy is performed by the MFAS 102 and the MFAP 106. For example, the SP 108 may request an authentication that achieves a particular assurance level (AL), and the AL may be separated into a local assurance level (AL_loc) and a network assurance level (AL_net) according to pre-defined rules. In some cases, the MFAS 102 can split the AL and send the AL_loc to the MFAP 106 in the authentication request. In other cases, the MFAP 106 may negotiate a requirement with the MFAS 102 in accordance with local contextual conditions and/or locally maintained device capability information. By way of example, the MFAP 106 may respond to the MFAS 102 to indicate a lower AL_loc capability as compared to a typical AL_loc capability, for example, because light conditions are currently insufficient for biometric face recognition. In response, continuing with the example, the MFAS 102 may adapt the AL_net accordingly (e.g., increase the AL_net), such that the overall AL can still be achieved. Alternatively, the MFAS 102 may adapt the MFAP policy to meet the required AL.

Referring particularly to FIG. 2, in accordance with the illustrated example, at 202, the user 110 requests to sign in to a service that is provided by the SP 108. At 204, the user device 112 may send an identity of the user 110 to the SP 108. At 206, in accordance with the illustrated example, the SP 108 specifies an assurance level (AL) that is required by the SP for user authentication, such that the user 110 can access the service. In some cases, the SP 108 may have previously negotiated policies (including required assurance levels) with the MFAS 102 as part of a service level agreement. At 208, the MFAS 102 may obtain information related to the user 110 from a user or user profile database 114a for maintaining user profile information related to a plurality of users. At 210, the MFAS 102 may obtain policies specified by the SP 108, from a service provider database 114b for maintaining policy information related to a plurality of service providers. At 212, based on the obtained policies and user profile information, the MFAS 102 may provide an authentication factor or a list of authentication factors that can be executed to satisfy the required AL. At 214, in accordance with the illustrated example, the MFAS 102 determines a current authentication status (e.g., a current assurance level) related to the user 110 and the user device 112. For example, the MFAS may access a user authentication database 114e to determine the current authentication status. At 216, the MFAS 102 determines whether the current authentication related to the user 110 and user device 112 is valid (not expired) and sufficient as compared to the required AL. If the current authentication is not valid or sufficient, the process may proceed to 218, where the MFAS 102 selects the authentication factors that should be executed. In doing so, the MFAS 102 may obtain authentication capabilities from a device or user equipment (UE) database 114c for maintaining authentication information related to a plurality of user devices. For example, the device database 114c may maintain a list of which authentication factors each device is capable of performing (e.g., fingerprint, iris scan, etc.). The device database 114c may also maintain a rank of each authentication factor as it relates to each device.

Still referring to FIG. 2, at 220, the MFAS 102 may determine how the authentication is separated between local and network-based authentication. The MFAS 102 may also determine the local assurance level (AL_loc) and network assurance level (AL_net). At 222, in accordance with the illustrated example, the MFAS 102 determines whether the authentication capabilities of the user 110 and user device 112 are sufficient to achieve the required AL. If there are adequate authentication factors available, for example, the process may proceed to 224, where the local and/or network-based authentications are performed. In some cases, if authentication factors were previously performed, those authentication factors may still be “fresh”, and thus those authentication factors can be asserted without being re-authenticated, thereby avoiding a potential authentication burden on the user 110. By way of example, a previous sign-in requesting a high authentication assurance level conducted five minutes ago may serve as a valid authentication for low assurance level requests. By way of further example, if the same authentication was conducted a few seconds ago, this authentication may still be considered fresh to allow access to a new service at the same high assurance level. It will be understood that the time in which an authentication factor retains its assurance level may vary as desired.

If it is determined at 222 that the collection of available authentication methods (functions) are not sufficient to achieve the required assurance level, the process may proceed to 226, where security diversity is utilized to achieve a higher level of assurance as compared to what the available authentication methods can achieve. For example, multiple challenge-response questions may be asked of the user 110 to increase the assurance level of the user 110 and the user device 112. The security diversity at 226 may be performed after, before, or in parallel with 224. After the authentication factors are executed at 224, the process may proceed to 228. At 228, in accordance with the illustrated example, the assurance level that is achieved by the authentications is sent to the SP 108 in an assertion. At 230, the MFAS 102 and/or the MFAP 106 may record (log) the individual authentication factors that were carried out, the respective assurance levels achieved by each authentication factor, and their corresponding timestamps for future use. The information, which may be collectively referred to as user authentication information, may be stored in a user authentication database 114d that includes at least one lookup table. The information in the user authentication database 114 may be obtained by the MFAS 102 when the MFAS 102 determines a given user's current authentication assurance status, at 214.

With continuing reference to FIG. 2, the device database 114c may include a lookup table that is populated with a list of available authentication methods (functions) associated with each device. Each available authentication method may be associated with attributes that are also associated with each device. Example attributes include an assurance level, a time period during which an authentication is valid, a metric indicative of a timestamp when an authentication factor was successfully performed and of an elapsed time validity, and a rank of each authentication factor in accordance with burden on a user for sign-in authentications. Another attribute may define how the AL of a given authentication factor combines with other authentication methods (factors). Such an attribute may serve as a guideline to combine synergies between authentication factors to increase an individual AL associated with a particular user or device. It will be understood that embodiments are not limited to the above-described attributes, and additional, or alternative, attributes may be associated with various authentication factors as desired.

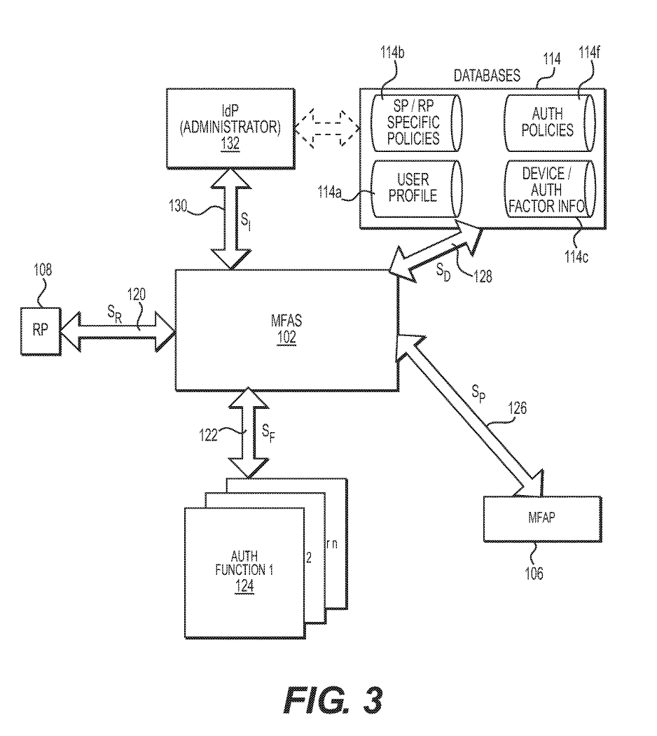

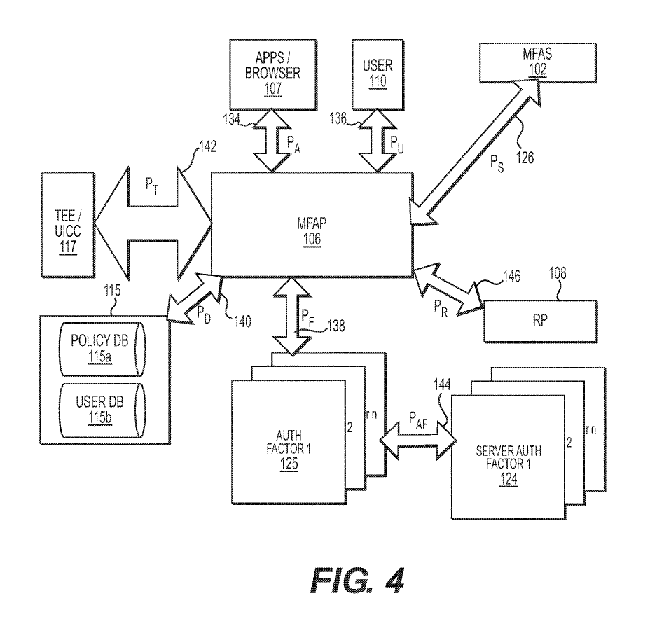

FIG. 3 is a diagram showing example functional components that may interact with the MFAS 102 on the server side. FIG. 4 shows the example MFAP 106 on the user device side and example interfaces between the components. Referring in particular to FIG. 3, an S_{R} interface 120 is between the MFAS 102 and the SP 108, which can also be referred herein to as an RP 108, without limitation. Using the S_{R} interface 120, OpenID Functions (e.g., Discovery, Association, Assertion) may be invoked, an assurance level that is required by the RP 108 may be communicated from the RP 108 to the MFAS 102, and policies may be negotiated between the RP 108 and the MFAS 102. An S_{F} interface 122 is between the MFAS 102 and authentication functions 124 or proxies of authentication functions 124. Using the S_{F} interface 122, the MFAS 102 may invoke services provided by each of the authentication functions (factors) 124, which may be implemented by respective authentication servers. Using the S_{F} interface, each authentication function 124 (e.g., authentication server) may send the results of a network-based authentication carried out by the respective authentication function to the MFAS 102. For purposes of this example, an S_{P} interface 126 is at least similar to the P_{S} interface 126, which is described below with reference to FIG. 4. As shown, an S_{D} interface 128 is between the MFAS 102 and one or more databases 114. In accordance with the example, databases 114 include the user profile database 114a, the service provider database 114b, the device database 114c, and an authentication database 114f. It will be understood that the databases 114 may include other databases as desired. It will further be understood that the databases 114 may include less databases than the illustrated databases. For example, the databases 114 may consist of one database in accordance with an example embodiment. Using the S_{D} interface 128, the MFAS 102 may obtain and update user profile information, obtain and update MFA results and authentication factor information, obtain and update policies relating to service providers, obtain and update authentication policies, and log authentications and authentication results including freshness information and assurance level information. As shown, an S_{I} interface 130 is between the MFAS 102 and an administrative third party, for instance an IdP 132. Using the S_{I} interface 130, a given third party can configure MFAS policies tailored to the third party, update the user profile database 114a and configure parameters associated with each user, and update policies specific to a given SP.

Referring now to FIG. 4, the illustrated interfaces are described below in accordance with the illustrated embodiment. As shown, a P_{A} interface 134 is between a browser 107 or applications 107 (which can collectively be referred to as browser/apps 107) of the user device 112 and the MFAP 106. Using the P_{A} interface 134 , the browser/apps 107 may invoke a function of the MFAP 106 (which may be access controlled) for configuration purposes, to obtain details of a current status of an authentication factor performed in an MFA, to obtain or update or provide a federated identity or temporary identity associated with a current and successful authentication, to provide the required assurance level (ALREQ) from a given application to the MFAP 106, or the like. As shown, a P_{U} interface 136 is between the MFAP 106 and the example user 110. The user 110 may, over the P_{U} interface 136, invoke the MFAP 106 for configuration purposes. The P_{U} interface 136 may also be used if the MFAP 106 controls a factor of authentication locally. For example, the MFAP 106 may perform a user password authentication without a separate user authentication application. As shown, the P_{S} interface 126, which may be protected by TLS and/or HTTPS, is between the MFAP 106 and the MFAS 102. Using the P_{S} interface 126, the MFAP 106 may register with the MFAS 102 and keys (e.g., long-term secret and signing keys) may be generated. Such keys may protect sessions between the MFAP 106 and the MFAS 102. Further, using the P_{S} interface 126, the MFAS 102 may communicate policy and configuration information to the MFAP 106, the MFAS 102 may invoke services of the MFAP 106, the MFAS 102 may provide an assurance level requirement, and the MFAP 106 may provide authentication results back to the MFAS 102. Further, in some cases, the MFAP 106 provides logging information on a regular basis to the MFAS 102.

Still referring to FIG. 4, a P_{F} interface 138 is between the MFAP 106 and one or more local authentication factor functions 125, which may also referred to as authentication factor modules 125. Using the P_{F} interface 138, the MFAP 106 may invoke each authentication factor function 125. For example, the MFAP 106 may provide a user identity (ID) or device ID as input when invoking a given authentication factor module 125, and a given authentication factor function 125 may return an authentication result, timestamp, assurance level that is achieved, or the like. As shown, a P_{D} interface 140 is between the MFAP 106 and one or more local databases 115 (e.g., SQL Lite or database for objects (DB4O)). Using the P_{D} interface 140, the MFAP 106 may obtain information about a particular user (e.g., for a user database 115b); obtain information related to authentication results, assurance levels, and timestamps (freshness); write updated information concerning a user; write the latest authentication results, timestamp, or the like; write policies provided by the MFAS 102 into a policy database (DB) 115a; or obtain policies concerning MFA, for instance a particular authentication factor, in order to make a determination about an on-going authentication request. As shown, the user device 112 may include a secure module 117, for instance a trusted execution environment 117 or a UICC 117, and a P_{T} interface 142 (which may be compliant with an OpenMobile API or Global Platform) is between the MFAP 106 and the secure module 117. Using the P_{T} interface 142, the MFAP 106 may, for example, query the secure module 117 for any long-term or short-term identities that may be stored in the secure module 117, invoke secure cryptographic functions stored within the secure module 117 for the generation of cryptographic keys, or query the secure module 117 in order to perform one or more cryptographic operations (e.g., encryption, integrity protection, computation of authentication results, etc.). The secure module 117 (e.g., TEE or UICC) may respond over the P_{T} interface 142 with appropriate results for the crypto function that was requested. As shown, a P_{AF} 144 may be between the MFAP 106 and each authentication factor 125 (e.g. Bio-key), and a P_{R} interface 146 may be between the MFAP 106 and the SP 108.

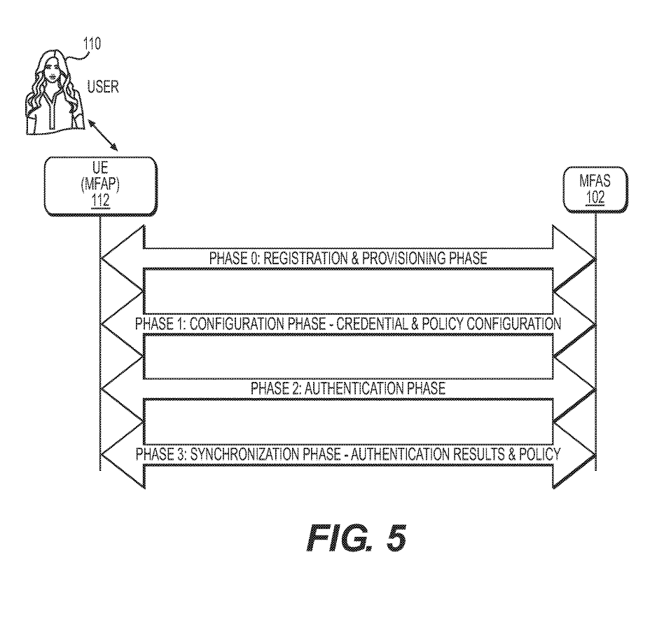

Referring now to FIG. 5, various phases involved in enabling MFA are shown in accordance with an example embodiment. As shown, in accordance with the illustrated embodiment, phase 0 is the Registration and Provisioning Phase. In this phase, the user 110 registers with an Identity Provider (e.g., MFAS 102). For exemplary purposes, as described herein, the user registers with the MFAS 102, though it will be understood that the user may register with any suitable identity provider or with a provider that provides multi-factor authentication as a service. The user 110 is provisioned with an identity that belongs to the administrative/security domain of the MFAS 102. The user 110 may be provisioned with credentials (e.g., password, certificates, long-term keys). The password (PWD) and other credentials may be selected by the user 110 or selected on behalf of the user 110 by the MFAS 102. The credentials may be registered within the user profile database 114a at the MFAS 102. In addition, presented by way of example without limitation, multiple identities of the user 110 associated with other identity providers (IdPs) may be bound together, identity proofing for the provisioned identity may be carried out, and multiple authentication factor identities (possibly from multiple third parties) may be bound together.

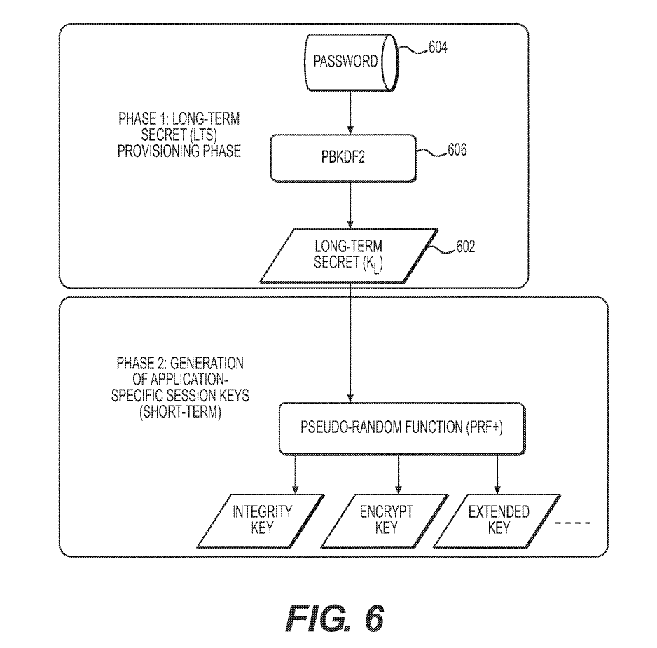

Still referring to FIG. 5, phase 1, which can be referred to as the Configuration Phase, may consist of sub-phases of credential configuration and policy configuration. During the credential configuration phase, in accordance with the illustrated embodiment, the MFAP 106, optionally in conjunction with the MFAS 102, may derive keying material that may be used for generating keys (e.g., Long-Term Key(s), Principal Signing Key (PSK), Session Keys, etc.). Generation of the keying material may be based on, for example, a Pseudo-Random Key Generation Function (PBKDF)-type process that may use the password (which may be provided by the user using a secure user interface) that was provisioned during the phase 0. Alternatively, symmetric keys may be generated using Pseudo-Random Functions (PRF) based on an initial key that was provided during the provisioning phase (e.g., see FIG. 6). If asymmetric keys are used, then public/private key pairs may be generated and registered with the MFAS 102. In addition, the MFAS 102 may provision the MFAP 106 with a server certificate associated with the MFAS 102. The MFAP 106 may optionally register a device or other certificates with the MFAS 102. In some cases, session keys are generated in order to protect communications between the MFAP 106 and the MFAS 102 that occur during the subsequent phases.

During the policy configuration phase, in accordance with one embodiment, the MFAS 102 provides the MFAP 106 with policy information that mirrors User/UE policies that are stored at the MFAS 102, for instance in one of the databases 114. Such policies may be primarily associated with the multi-factor authentication process. Policies may be User/UE-specific policies that are tailored based on the capabilities of the user and or device(s) associated with the user. In addition, service provider (SP/RP)-specific policies may be provided by the MFAS 102 and configured by the MFAP 106 locally. RP-specific policies may be based on service agreements between the RP 108 and the MFAS 102, or based on the user and RP from prior transactions that may have been logged elsewhere. The RP-specific policies may be updated regularly based on user interactions with RPs. With respect to the provisioning and configuration of policies locally, the MFAP 106 may behave as a proxy of the MFAS 102, and therefore may perform functions locally as a counterpart to the network Policy Engine, Policy Decision Point, and Policy Enforcement Point. The communications involved in this phase between the MFAP 106 and the MFAS 102 may be protected using a secure tunnel, and may be based on the keys that were derived as part of the credential configuration phase.

Still referring to FIG. 5, during phase 2 (authentication phase), based on the request for a service from the user 110 to a local application on the device 112 (which may also be referred to as a user equipment (UE) 112, without limitation) or to a given SP on the network, the application or SP may trigger an authentication process involving the user 110 and/or the user device 112 and the MFAS 102. Based on the policies at the MFAS 102 and the mirrored policies at the MFAP 106, the various factors of authentication may be carried out. The authentications may be orchestrated by the MFAS 102 or orchestrated by the MFAP 106 based on policies. During phase 3 (synchronization of authentication results and policies), in accordance with the illustrated embodiment, the authentication results are communicated by the MFAP 106 to the MFAS 102 and visa-versa. The MFAP 106 and MFAS 102 may be in lock-step and in-synch with regard to the authentications that were carried out at either of the ends (server 102 and device 112). In one example, at any instance both the MFAP 106 and the MFAS 102 has information on the authentications that were carried out, the time (freshness) of the authentication factors were carried out, the individual assurance achieved per authentication factor, and a cumulative assurance level that has been achieved. Mechanisms to ensure that the authentication results are communicated in a secure manner may be achieved by using a TLS connection between the MFAP 106 and the MFAS 102. In some cases, the MFAS 102 may perform a policy update with the MFAP 106 on a regular basis, for example, based on the policies associated with the multi-factor authentication policies. Policy updates may be carried out in a secure manner to ensure that the integrity of the policy messages and authenticity of the originator of the update is maintained. The interface for policy updates may optionally ensure that policy update messages are confidential. Policy updates may be carried out using a pull mechanism, wherein the MFAS 102 triggers the MFAP 106 to connect with the MFAS 102 using side-channel mechanisms (e.g., SMS). Optionally, the MFAS 102 may perform push mechanisms in order to push policies onto the MFAP 106.

With continuing reference to FIG. 5, during phase 0, in accordance with an example, a user who wants the services of the MFAS 102 registers for the service using either web-based means or in-person mechanisms. As part of the registration process, the user's identity may be verified using government issued identities (e.g., use of driver's license, passport, etc.), using Internet identities provided by other identity providers (e.g., email providers, social media providers, etc.), or using identities provided by an organization (e.g., enterprise identities associated with the user's job, professional association, etc.). The strength of the identity proofing process may depend upon the requirements established by the MFAS 102, which may be further influenced by requirements originating from service providers (e.g., Commercial web services/portals, government services, work-related, etc.). A user may be provided with options to select other identities that may be bound with the identity issued by the MFAS.

The user's MFAS identity may also be associated with other identities that may belong to specific factors of authentication, and which would be used to perform multi-factor authentication using those specific factors of authentication. An example of such other identities may be a user's mobile subscriber identity (e.g., IMSI).

As part of the provisioning phase, the user may be provisioned with credentials associated with the identity issued by the MFAS 102, which, as mentioned above, may provide multi-factor authentication as a service. In some cases, the credentials provisioned may be temporary in nature and may have to be changed immediately upon activation or periodically, for example. In some instances the credentials may be long-term. The credentials provisioned may be passwords, cryptographic keys (may be remotely provisioned), certificates, public keys, or the like. The credentials may be provisioned and associated with the identity and the MFAP 106. Alternatively, credentials may be generated out of a device-based key (e.g., associated with the secure module 117 functionality residing on the user device 110 or derived out of chip-based master key residing on the user device 110).

Turning now to phase 1, in accordance with one example, prior to initial use, the MFAP 106 may be discovered and configured by the MFAS 102 such that policies, parameters, and authentication capabilities are shared between the MFAP 106 and the MFAS 102. Based on the discovery and configuration, the parameters for policy management (e.g., factors associated with a user/device, assurance levels associated with each factor, retry-counters, freshness, and decay factors) may be populated in a user profile database either in the MFAS 102 (e.g., user database 114a), MFAP 106 (e.g., user database 115b), or both. In some cases, the MFAS 102 derives the setting of these values and the values are synchronized between the MFAS 102 and the MFAP 106. Additionally, as part of this procedure, the MFAS 102 and MFAP 106 may generate necessary keys that may be used during authentication and during other interactions between the MFAS 102 and MFAP 106, for example, to provide additional cryptographic security in the messaging between the MFAS 102 and the MFAP 106. The interaction also may be provided over HTTPS/TLS to provide additional security on the transport layer of communication between the MFAS 102 and the MFAP 106.

Referring also to FIG. 6, with respect to configuration, the MFAS 102 and the MFAP 106 may establish a Symmetric Long-Term Secret (LTS) 602, which may be viewed as a root key, used for subsequent key generation. The LTS 602 may be pre-provisioned to the MFAP 106 by the MFAS 102, or alternatively, the LTS may be derived from a user password 604 by using a key-generation based on a Pseudo-Random Key Generation Function (e.g., PBKDF2 606) as shown in FIG. 6. In an alternative embodiment, public keying mechanisms may be used for authentication and secure channel establishment between the MFAP 106 and the MFAS 102. The MFAS server certificate may be pre-provisioned to the MFAP 106 and visa-versa. In yet another embodiment, public/private keys may be registered between the MFAP 106 and the MFAS 102 without the need for certificates on a dynamic basis without preconfiguration. The MFAP 106 may be able to use the services of the underlying Trusted Execution Environment 117 (Secure Environment) to provide for authentication during the initial provisioning.

In accordance with an example embodiment, the MFAP 106 securely stores credential information, such as passwords and public/private keys for example. With respect to passwords, once the provided user password has been verified to match the password that has been stored at the MFAS 102 (e.g., using LDAP), the MFAP 106 may store the password to verify a password entered by the user during local password authentication. The password may, for example, be stored in the MFAP 106 database 115b in hashed form with a randomly generated nonce instead of, or in addition to, storing the password in clear text.

With respect to the generated public/private keys, in accordance with one example embodiment, if a given device has a trusted execution environment (TEE) where keys and objects may be stored securely (e.g., as a persistent object), the MFAP 106 may store the keys as a secure object, with the persistence of the keys continuing through the allocated lifetime of the keys. Alternatively, if a given device does not have a TEE, the generated keys may be stored with limited persistence in the memory of the MFAP 106. The persistence of the keys in this case may be limited and subject to the memory allocation and application management function of the device. As such, in some cases, a procedure in which the MFAP 106 detects the lack of keys and is re-generated may be necessary if the MFAP 106 does not detect any keys when signing the MFAP identity (ID) during the query from the MFAS 102. In order to ensure that the keys may be re-generated prior to authentication, for example, the MFAS 102 may ensure that local password or network password authentication is run such that the keys may be re-generated.

In accordance with an example embodiment, as part of the policy framework configuration process, the MFAS 102 may configure a policy specific to local authentication operations. For example, the policy may be established for the device for all sites or for specific sites or services, or there may be a combination of site-specific and generic policies depending upon the services required by the user device. The policy may enable the MFAP 106 to determine the set of authentication factors to be run for a certain required assurance level that needs to be achieved. The policy may prioritize certain authentication factors. Prioritization may be based on a number of variables. For example, factors may be ordered (prioritized) based on the ones that provide the least amount of friction from a user perspective. This policy configuration procedure may be done by the MFAS 102 to the MFAP 106 as needed after initial discovery, for instance during or after local authentication.

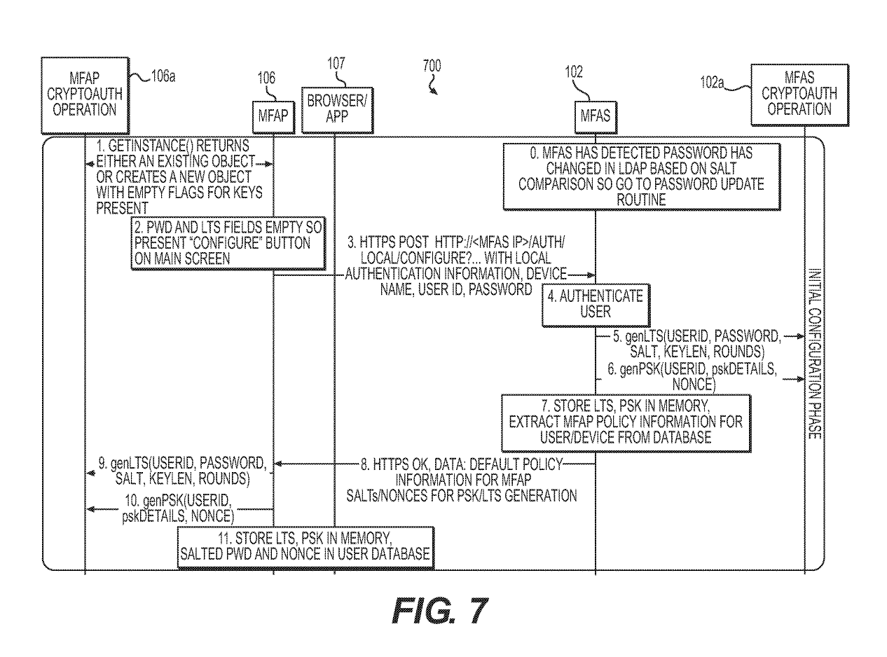

Initial MFAP configuration interaction between the MFAP 106 and MFAS 102 (e.g., see step 3 in FIG. 7) may be performed over a secure channel (e.g., HTTP over TLS). In some cases, signaling between the MFAP 106 and the MFAS 102 may be performed over a channel that is secure and different from OpenID communications that is used between the UE and the MFAS by means of a browser. For example, secure communications between the MFAP 106 and the MFAS 102 may be initiated by the MFAP 106 by an HTTP GET message over a TLS connection. Alternatively, the MFAP 106 may be triggered into setting up an HTTPS connection by the MFAS 102 using a side-channel PUSH notification (e.g., SMS or other PUSH notification or Device Management mechanisms).

In one example, TLS establishment and handshake may occur directly between the MFAS 102 and the MFAP 106, and may follow standard TLS procedures. In some cases, the MFAS 102 is authenticated by a server side self-signed certificate by the MFAP 106. In an example embodiment, client side certificate authentication is not used but may be applied as desired. In some cases, the MFAP 106 may use PSK to authenticate with the server side, or TLS-PSK may be used for mutual authentication and secure communication between the MFAP 106 and the MFAS 102. Thus, the authentication results from the MFAP 106 to the MFAS 102 are protected for integrity and optionally for confidentiality by means of a TLS connection. In addition, any synchronization or policy update information is also protected (integrity and optionally for confidentiality) by means of the TLS connection. Initial configuration may emulate a scenario in which a user has installed the MFAP 106 on a device for the first time and needs to configure the MFAP 106 with a MFAS 102 prior to any authentication attempts. For this purpose, an option (e.g., button) may be added to a graphical user interface (GUI) of the MFAP 106 to trigger the initial configuration procedure.

Referring now to FIG. 7, an example system 700 includes the MFAP 106, the browser/app 107, and the MFAS 102. The system 700 also includes a MFAP CryptoAuth operation 106a and a MFAS CryptoAuth operation 102a. It will be appreciated that the example system illustrated in FIG. 7 is simplified to facilitate description of the disclosed subject matter and is not intended to limit the scope of this disclosure. Other devices, systems, and configurations may be used to implement the embodiments disclosed herein in addition to, or instead of, a system such as the illustrated system, and all such embodiments are contemplated as within the scope of the present disclosure.

FIG. 7 shows an example of a configuration of a policy framework. There may be various triggers that initiate the configuration to occur. Various example triggers are discussed below. In accordance with the illustrated example, at steps 0, 1, and 2, the MFAS 102 may detect a password change in the user database 114a, which is an LDAP for purposes of this example, and as a result may need to update the keys and provide information to update the keys to the MFAP 106. Alternatively, configuration may also be triggered by the end user device 110, in particular the MFAP 106. A user may push “configure” a button on a GUI of the MFAP 106. This may open another window (activity) and prompt the user for further information, which may include, for example and without limitation: a URL or IP address of the MFAS 102; a username (e.g., jimjones) associated with the user; a device name (e.g,. Samsung S4); an indication of the presence of a TEE; a password, an identity of the MFAP 106 (MFAP ID); and a list of authentication factors that are supported by the are supported by the device 112 and the MFAP 106 in a predefined device name string (e.g., “fingerprint” or “password”). In some cases, the username may take the form of http://<MFAS IP>/u/<username> to follow OpenID convention. The device name may be selected from a predefined set of possible device names. The device name may also be pulled from the device's base operating system (e.g., Android System). In some cases, an application may detect the presence of a TEE on the device 110. The password may be used to authenticate the user, for example the MFAP 106, with the MFAS 102. In some cases, the password may also be used to generate the long term secret (LTS) that is used to generate the PSK/SSK (Session Keys). This may be sent as clear within a secure TLS connection. The MFAP ID may be a unique identity that identifies the MFAP 106. For example, the MFAP ID may be allocated to a particular MFAP instance on the device at the configuration or installation time.

Still referring to FIG. 7, in accordance with the illustrated embodiment, any or all of the above-described information may be sent from the MFAP 106 to MFAS 102 using the illustrated HTTP GET/POST message. At 4, in accordance with the illustrated example, the MFAS 102 verifies user credentials with the LDAP. At 5 and 6, the MFAS 102 generates a new LTS and PSK based on the verified credentials of the end user (e.g., user device 110 and user 112). At 7, the MFAS 102 stores the LTS and PSK into one or more of database 114 and constructs the policy configuration for the MFAP 106. In some cases, the policy configuration is constructed based on information stored in one or more of the databases 114. At 8, in accordance with the illustrated example, the local authentication policy information is sent to the MFAP 106 via HTTPS. At 9 and 10, based on the received configuration, the MFAP 106 generates the LTS and PSK. At 11, information that is necessary for MFAP 106 to fill at least one of its databases 115, which may be a database for objects (DB4O), with policy information may be provided by the MFAS 102. Other information that is provided by the MFAS 102 during configuration may include, for example and without limitation: a Salted Password (as stored in LDAP, and after password provided by user has been authenticated and verified); a Salt, as stored in LDAP; a nonce, as used for LTS generation; an LTS validity period (time that the LTS is valid) that does not change; a (Second) Salt (to be used for PSK generation); and a PSK validity period, which represents a time that PSK is valid.

In accordance with an example embodiment, one or more databases 114 are organized to enable efficient policy execution. A function of the MFAS 102 is to enable discovery of authentication factor capabilities of a user and a device, and then execute one or more factors to authenticate a user. The user authentication is carried out in alignment with service provider policy requirements. It is recognized herein that gathering and managing all of these features at an individual user data record can be overwhelming in terms of the volume of data, data duplication, and management, especially, for example, when the MFAS 102 is implemented with a large scale user database.

Thus, an important feature of the MFAS architecture described herein is to enable efficient accommodation of service provider policies in terms of the various factors of authentication that are available for a user/device combination. As described herein, in various embodiments, there also is a capability to subsequently manage the policies on a large scale. So, for example, if an aspect of a policy needs to be changed, there is not a need to go into a user database record to change information relating to one parameter corresponding to an authentication factor attribute, such as level of assurance achievable or retry count, etc.

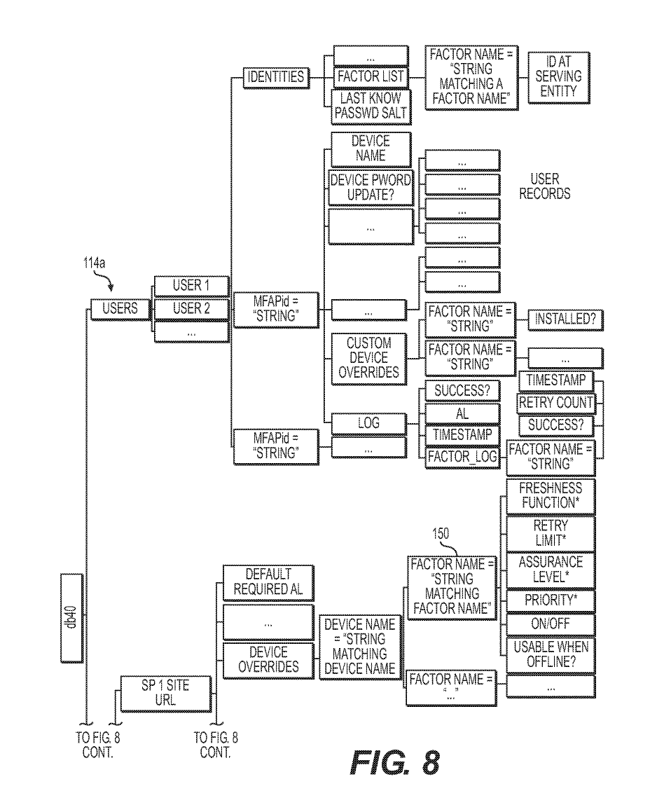

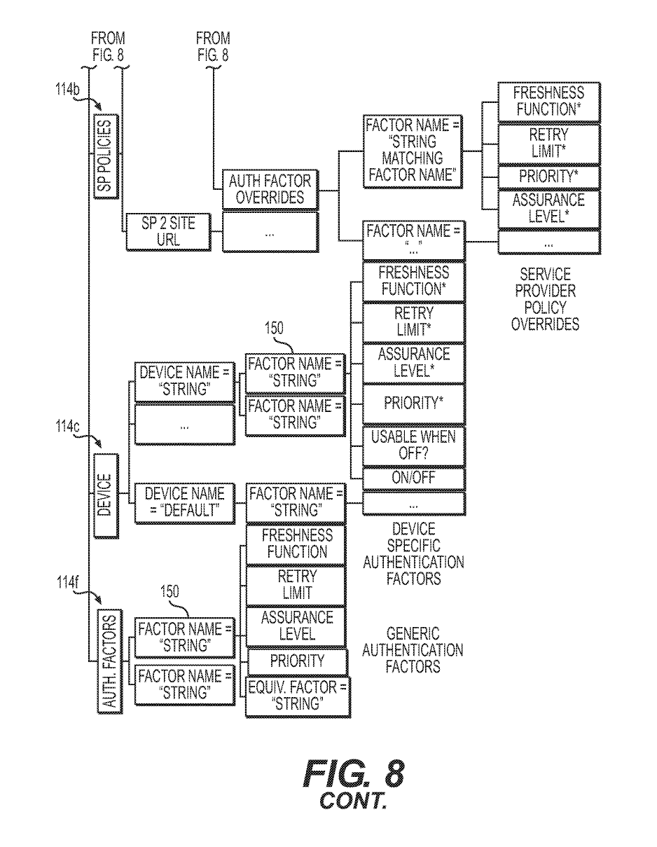

In order to accommodate service provider policies while handling a large number of users who use a variety of devices, static database data may be used to dynamically generate the actual authentication record and data used for an authentication session execution, in accordance with one embodiment. Referring to FIG. 8, in accordance with the illustrated example, the MFAS 102 may maintain the user profile database 114a, the service provider database 114b, the device database 114c, and the authentication database 114f. The authentication database 114f, as shown, may include characteristics associated with each of the authentication factors that the MFAS 102 can invoke. For example, the authentication database 114f may include generic parameter values or attributes associated with various authentication factors. The service provider database 114b may include authentication policies set by each of a plurality of service providers. The device database 114c may include authentication capabilities (e.g., authentication factors) associated with each of a plurality of user devices. The device database 114c may also include generic parameter values or attributes associated with each authentication factor or each device. The user profile database 114a may hold overrides to the user specific authentication factor settings or attributes, and to other information for a user data record, including results of an authentication factor for example. As will be understood by referring to FIG. 8, the user profile or user database 114a can also be referred to as a “users” tree, the SP database 114b can also be referred to as an “SP policies tree”, the device database 114c can also be referred to as a “device” tree, and the authentication database 114f may also be referred to as an “authentication factors” tree.

In accordance with the illustrated embodiment, the user profile database 114a, the SP database 114b, and the device database 114c may be implemented to create an on-the-fly dynamic record of a given service provider and a given user device, which may include a specific tailored set of authentication factor attributes. These may be combined with the session information for a user, and held in the user database 114a, to create a user authentication record that is used as the basis of performing a particular user authentication.

As shown, an example authentication factor record 150 includes various attributes, such as, for example, an assurance level that is achievable, a freshness function, a retry limit, a priority, an equivalent factor, a useable attribute, and an on/off attribute. The freshness function may indicate how an authentication assurance level changes over time (e.g., decreases) after the authentication factor has been performed. Typically the assurance level reduces (or decays) over time. The freshness function captures the characteristics of the decay. For example, assurance level may decay linearly, exponentially, or in accordance with a step function. The retry limit refers to how many times a user is allowed to re-attempt the authentication. The priority attribute indicates how this factor ranks in terms of ease of use or in terms of priority handling from a service provider perspective. The equivalent factor attribute may indicate whether a factor can be executed on the device or on the network without the factor being changed from the perspective of the user (e.g., fingerprint authentication). The useable attribute may indicate whether the authentication factor may be used for local authentication on the device even when the device is offline or detached from network connectivity. The on/off attribute indicates whether the authentication factor is enabled or not.

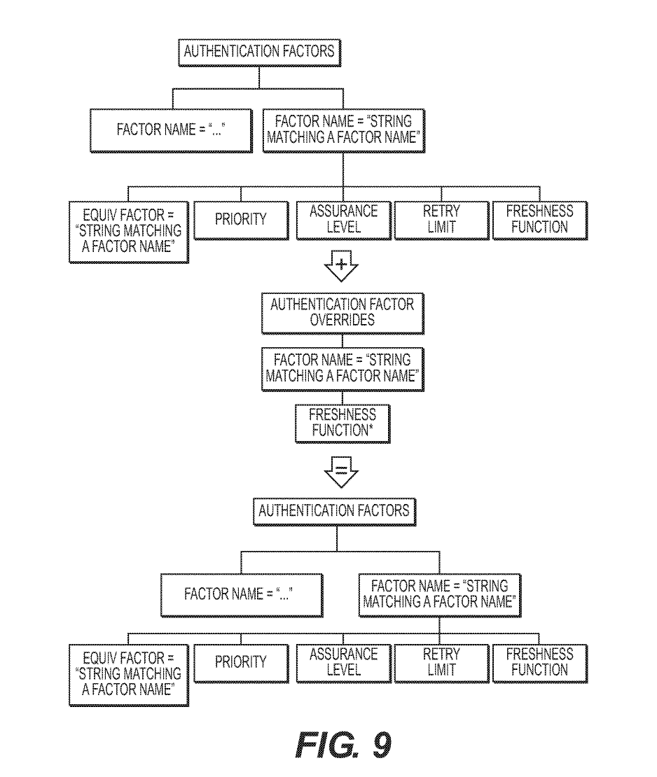

FIG. 8 shows an example overview of the various databases as described above. FIGS. 9-13 show examples of how the database information can used to create a user session record for authentication execution. The details enable a dynamic record to be created, which enables specific authentication factor attributes for a specific user device to be determined in accordance with a given services provider's policies for execution of MFA. The authentication factor attributes will be described in further detail in the descriptions that follow. As will be understood

In some cases, the MFAP databases are similar to the MFAS databases, except that the MFAP databases do not include multiple “device name” entries under each of the databases. In addition, there may be “local salted password” and “local salt” in the MFAP user database 115b.

With respect to MFAP Policy Configuration, in some cases, the MFAS 102 trims the trees for the user/device combination. In some cases, because MFAS does not know which website or service the user is going to visit, the MFAS 102 does not override the “Device” and the “Authentication factors” with “SP Policies.”

By way of example, the MFAS 102 may trim or push the policy tailored for MFAP 106 by evaluating the branch in the “Users” tree under the particular user/device name combination, and removing factors that are not in the MFAS “Device” tree under the same device. This becomes “Users tree-mfap.” For each factor, this only contains an “installed?” parameter. A rationale for keeping the network factors is to allow the MFAP 106 to calculate the freshness of a network-only factor when the device authenticates the user offline. A network factor that has an equivalent local factor may become a network-only factor if a particular service provider policy disables the local factor. The MFAS 102 may further trim policy by evaluating the “Device” tree branch under the device name, and removing factors not in “Users tree-mfap”. This becomes “Device tree-mfap.” In some cases, the priority of any network factors in this tree will be set to 0. In an example embodiment, if a local factor whose priority is greater than 0 but less than the equivalent network factor, and i) if the local factor is usable offline, the local factor priority is multiplied by −1; or ii) if the local factor is not usable offline, the priority of the local factor is set to 0.

This conversion procedure of negative or zero priority may also be carried out for the SP policies tree-*-override-mfap and authentication factors tree-mfap described below. The MFAS 102 may evaluate the branch in the SP policies tree in “device overrides” for each site or service, and remove factors not in “Users tree-mfap”, thereby creating an SP polices tree-device-override-mfap. Factors that appear in the authentication factors tree, but not in the “Users tree-mfap”, may be removed, thereby creating “authentication factors tree-mfap.” The MFAS 102 may evaluate the branch in the SP policies tree in “authentication factor overrides” for each site, remove all factors not in “Users tree-mfap”, thereby creating an SP polices tree-factor-override-mfap. The SP policies tree-device-override-mfap may be merged with SP polices tree-factor-override-mfap to generate SP policies tree-mfap. The authentication factors tree-mfap, Device tree-mfap, SP polices tree-mfap, and Users tree-mfap may be sent to the MFAP 106 as policy. The MFAP 106 can create in-memory user profile objects to merge these trees using the same procedure that the MFAS 102 uses to generate the in-memory user profile. In addition, the MFAP 106 may update the timestamp/success of the local password factor when it receives that info from MFAS 102. This may happen before a network-initiated local authentication is carried out in accordance with one example.

In addition to the parameters described in the MFAS database 114, the MFAP database 115 also may store the following parameters in its database, presented by way of example and not by way of limitation: MFAP generated salt; MFAP generated salted password; and parameters used for browser plugin (e.g., dolphin-plugin or firefox plugin). Parameters used for a browser plugin may include an RP url, Openid input field name/id, submit button name/id, a User nickname, or the like

After the Configuration phase, and turning to phase 2 (authentication phase), in accordance with an example embodiment, a required assurance level (which can be referred to herein as ALREQ) needs to be achieved during user authentication by the MFAS 102 in order for the user to be allowed access to the service provided by the SP. The value of ALREQ may be a prespecified range (e.g., 1 to 10, where 10 is the highest required assurance level). Based on this required assurance level, the MFAS/MFAP determines the necessary authentication factors to execute or reexecute in order to meet the required assurance level.

In response to an authentication request from the RP 108, the MFAS 102 may return an authentication response assertion that may satisfy the required assurance level. In some cases, the MFAS includes the required (and authenticated) assurance level received from the RP in the signed assertion. The MFAS returns a negative assertion when the authenticated assurance level does not meet the required assurance level of the RP or, alternatively, the MFAS includes the achieved AL, within the response. The achieved AL may be equal, higher, or lower to the requested ALREQ. In some cases, it is up to the RP whether to then launch a dialog with the MFAS in order to determine the specific level of assurance achieved or factors executed (and related results). Based on that information, in an example, the RP may determine whether to allow the end user access to a service, limit the service provided to the user, or deny access.

As an example, from the RP, the ALREQ may be provided as part of an OpenID Association Request or Authentication Request to the MFAS. Below is an exemplary OpenID Authentication Request message with parameters. It will be understood that the ALREQ may be added as an extension message:

[Open ID 2.0 Authentication Request]
openid.ns=http://specs.openid.net/auth/2.0
openid.claimed_id=http://10.2.251.131:8081/u/jimjones
openid.identity=http://10.2.251.131:8081/u/jimjones
openid.return_to:http=//localhost:8080/MyShop/consumer_returnurl.jsp
openid.realm:http://localhost:8080/MyShop/consumer_returnurl.jsp
openid.assoc_handle=1−
vzrawredo2udlz6dddop4fh3emgin37vj93x5lcjnqm8h0bqo9wtle2guojvp6ystwx3aryoqs9olvkohc1
r0ohojei3tm0088ppc2w22fmwf88oj9pjp1rt1crh9dqotsb7ayix2kzu2blh0hek81rtzlorgd377xf53vh
fo3u8uonftj2fmcyzix2324bd0e1nmpgykm8z7nmfqceshuvgmue24krvpzooock1os9bikvr6kuvn0mi
openid.mode:checkid_setup
openid.ns.ext1=http://www.idcc.com/ssofarssogood
openid.ext1.ALreq=10

In some cases, the ALREQ parameter may be proprietary within the SP/RP domain, however, the RP and MFAS may be expected to agree upon the interpretation of the ALREQ and the mapping of it to an authentication strength that may be pre-agreed between the RP and MFAS, for instance based on a service level agreement (SLA) or based on well-established standards such as those developed by NIST.

Below is an example message of a positive assertion from the MFAS to the RP. The “alreq” parameter received from the RP is included as a parameter in the signed assertion response back to the RP from the MFAS. The “alreq” parameter represents the achieved AL, which is equal to the alreq that was requested by the RP. Note also that this response may be proprietary or there may be a parameter set defined in PAPE that may be used to provide the authenticated AL. In OpenID Connect, parameters such a “acr” and “amr” may be used to convey requested and achieved AL.

In accordance with an example embodiment, in order to meet the various forms of authentication policy requirements from service providers, the static database information, such as type of generic factors of authentication, authentication capabilities of different devices and service provider policy requirements for example, may be held in a database. When an authentication is to be performed, this static information can be used to determine a dynamic in-memory data record for a specific user/device/service provider requirement for authentication. This may avoid costly replication and management of data and yet still provide flexibility in terms of policy capabilities.

In some cases, the authentication factor database 114f provides the default settings for each authentication factor. This may provide a baseline reference for each type of factor in terms of level of assurance the factor provides and other default settings, such as retry limits, freshness function, etc.

In some cases, the device characteristics (device tree 114c) provide the default settings for each type of authentication factor a device supports. There may be an override on several parameters in order to tailor the generic factors settings for specific device level characteristics. So, for example, an Apple iPhone 5s's fingerprint authentication capability may be setup to have an assurance level of 5 as compared to a Samsung S5's assurance level of 4. For each device, the parameter settings from the generic factors information may be updated from the device information. Not all parameters need be configured for override. For example, if a parameter in the device information is set to “NULL” then this may be used to indicate that there is no override value for that parameter.

A service provider may just adopt the default suggested settings or may (SP policies tree 114b) override the default settings for the set of authentication factors and/or for a particular device. So when an in memory authentication capabilities record is being setup to authenticate a user for a service provider, the default factors (Authentication factors tree) and device characteristics (Device tree) for each device type are overridden first by the service provider policy. Then the resulting authentication factors are overridden by the resulting device factors information to create a representation of the authentication capabilities record for a specific device in accordance with the service provider policy.

Continuing with the above described example, the user database authentication record information may then be merged with the authentication capabilities record to create a user authentication record tailored for the specific device the user is using. This is the basis from which an authentication of the user is subsequently carried out. As an example of the process to create a user specific authentication data record, example steps are described in more detail below.

Referring to FIG. 9, the in-memory object in the MFAS 102 is constructed, as an input to policy engine, based on the order below in accordance with an example embodiment:

1. With respect to a SP authentication factors record, take all factors in the “authentication factors” tree 114f, store them in memory as a master reference for all factors.

2. Based on the service provider (RP) identifier, such as the site URL of the RP, find a service provider policy (e.g., SP policies tree 114b). Make a copy of the master factors table for the service provider. If the “authentication factor overrides” exists for a factor in memory, overwrite the factor policy with the content of “authentication factor overrides”. This is the factors table for the RP. Apply the SP policies tree to the authentication factors tree.

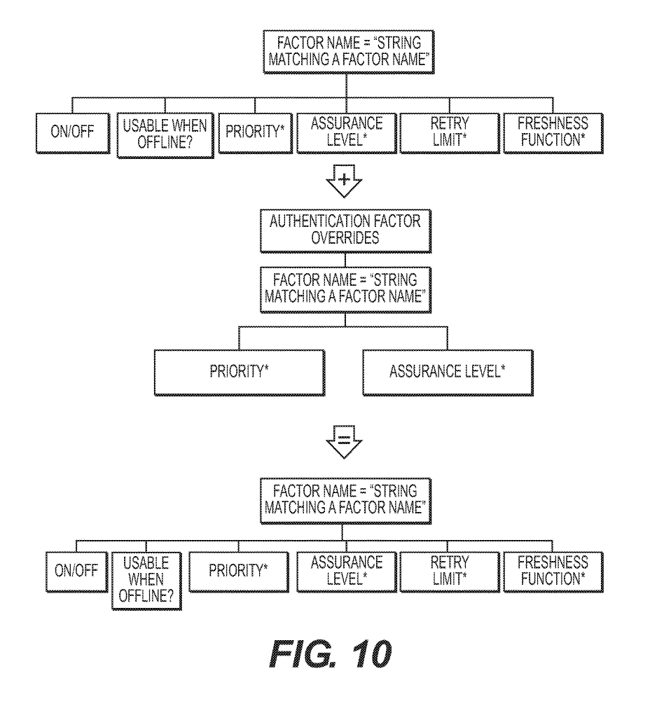

Referring now to FIG. 10, with respect to an example SP device record:

1. Create a service provider device characteristics table in memory from the master device characteristics (e.g., device tree 114c).

2. Based on the service provider (RP) identifier, such as the site URL of the RP for example, find a service provider policy. If the “device overrides” exists for a device in memory, overwrite the factor policy with the content of “device overrides”. Apply the SP policies tree to the device tree.

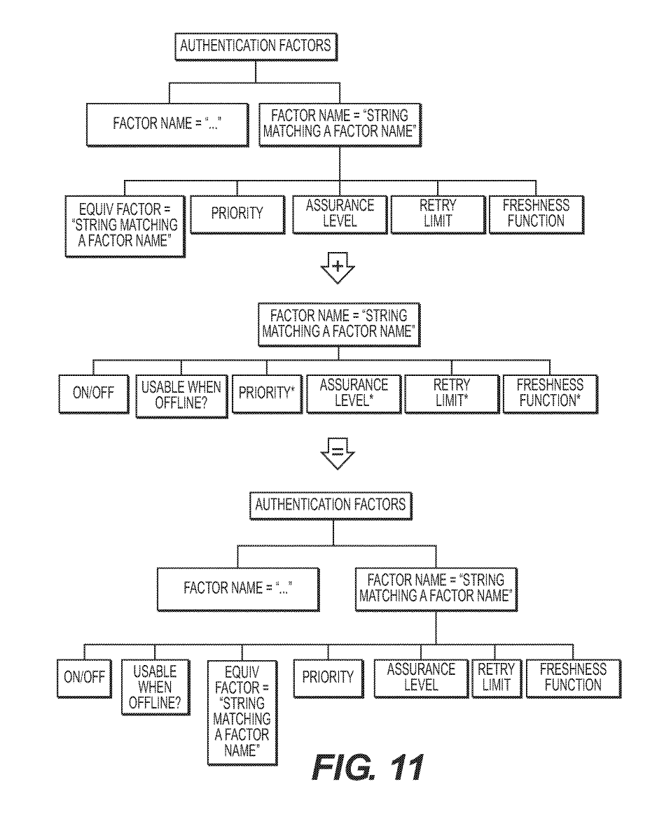

Referring now to FIG. 11, with respect to the Service Provider Device Specific Factors Record, in accordance with an example embodiment:

1. Now take the in memory “modified Device tree” and create a device record by inheriting entries from the in-memory “modified authentication factors tree” to create a “device” representation for the RP.

2. This is the device record for the RP. This is then applied for the authentication that follows.

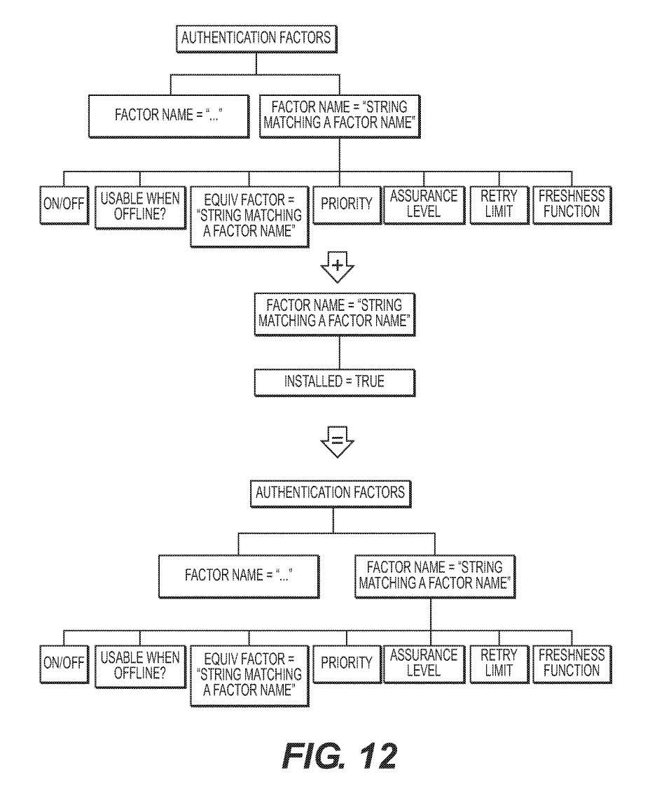

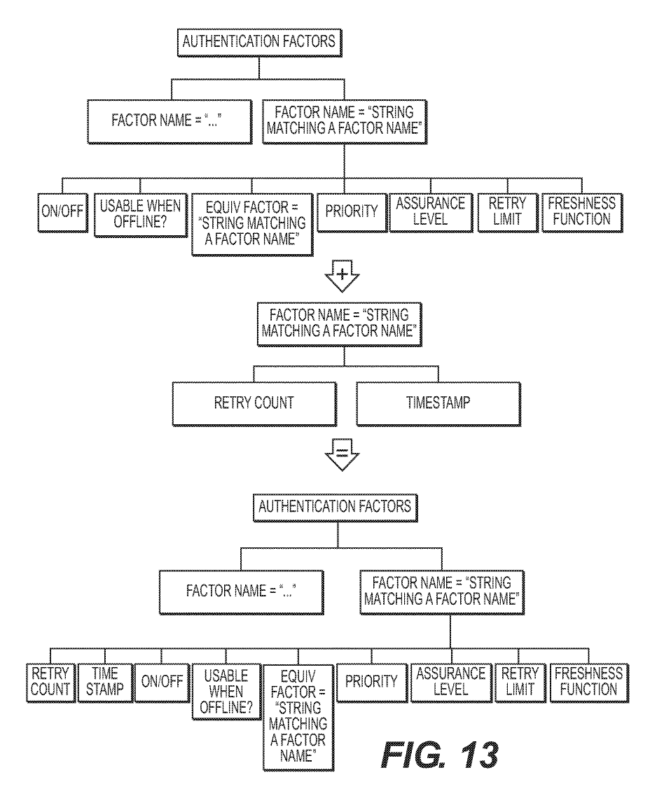

Referring now to FIGS. 12 and 13, with respect to the User Device Supported Factors Record, in accordance with an example embodiment:

1. Based on the user identifier, the user specific device policy is applied. If the “custom device over-rides” exists for the device/user (Users tree), the factor policy under the “factor name” is updated. This override tailors the authentication factor availability down to a specific user device, for instance the user device 112. If the factor is available (for example the authentication factor is installed in the device as a software function), the factor information is retained. If the factor function is not installed, for example, then the factor is turned off and prevented from being used.

2. The user authentication factor record may be augmented with the retry count reset to 0.

With respect to a User Authentication Session Record, in accordance with an example embodiment, the dynamic in-memory representation of the user authentication information is now available and ready to use for a user authentication.

1. A User Profile object is created which contains the authentication factor record as well as the various parameters associated with the user such as, presented by way of example and without limitation: Salted password; Last known password Salt; LTS_nonce and expiration time; PSK nonce and expiration time; reference to CryptoOperations object instance, in which LTS/PSK are generated/stored and indexed by “User MFAS ID/MFAP ID”; LTS that is generated using Salted password and LTS nonce; User MFAS ID; MFAP ID; and Temporary ID such as an Authentication Transaction Identity (ATID).

2. This User Profile object may now fed to the service provider authentication execution policy engine to perform the user authentication.

Turning now to performing the authentication, in accordance with an example embodiment, the MFAS 102 receives a required assurance level (ALREQ) from the RP 108 and derives an AL_{N} and an AL_{D}. The AL_{N} (which is also referred to herein as the AL_net) is the total assurance level obtained by performing network-based or network-assisted authentication factors. AL_{D} (which is also referred to herein as the AL_loc) is the total assurance level from performing local authentication factors on the device 112. The MFAS 102 may derive the authentication factors such that:

AL_{REQ}≦AL_{N}OPR AL_{D}

At a conceptual level, the operation (OPR) combining the local and network assurance levels (Als) may be flexible and programmable. In one example, all of ALs are added together to arrive at a cumulative assurance level. In such an example, the sum of the assurance level from each authentication factor should be equal/greater than AL_{REQ} in order for the user to obtain access to the requested service. The set of local and network authentication factors that are needed to meet the required AL may be determined by the MFAS policies, and may be based on information regarding available authentication factors, assurance levels of each authentication factor, freshness of a given authentication factor, and specific weighting factors.

In determining the necessary network authentication factors, the MFAS 102 may use information regarding the available authentication factors, the freshness state for each of those factors, and the policies related to each factor, to translate the AL_{N} to the factors of network based authentication that are executed.

For local authentication factors, the MFAS 102 may obtain, for instance from a previously executed discovery and configuration phase for the end user device 112, information regarding available local authentication factors, assurance level of each local authentication factor, and device/authentication specific weight for each of the factors. Additionally, the MFAS 102 may obtain information regarding previously executed local authentication factors based on information provided from the MFAP 106, and as such may be aware of the freshness of all available authentication factors. Based on this information, the MFAS 102 may then determine the set of local authentication factors to execute to meet the AL_{D}. In one example, the MFAS 102 then provides the MFAP 106 with the required assurance level that needs to be achieved by the local authentication factors. The MFAS 102 may provide the MFAP 106 with additional information regarding authentication factors that have already been run on the network side.

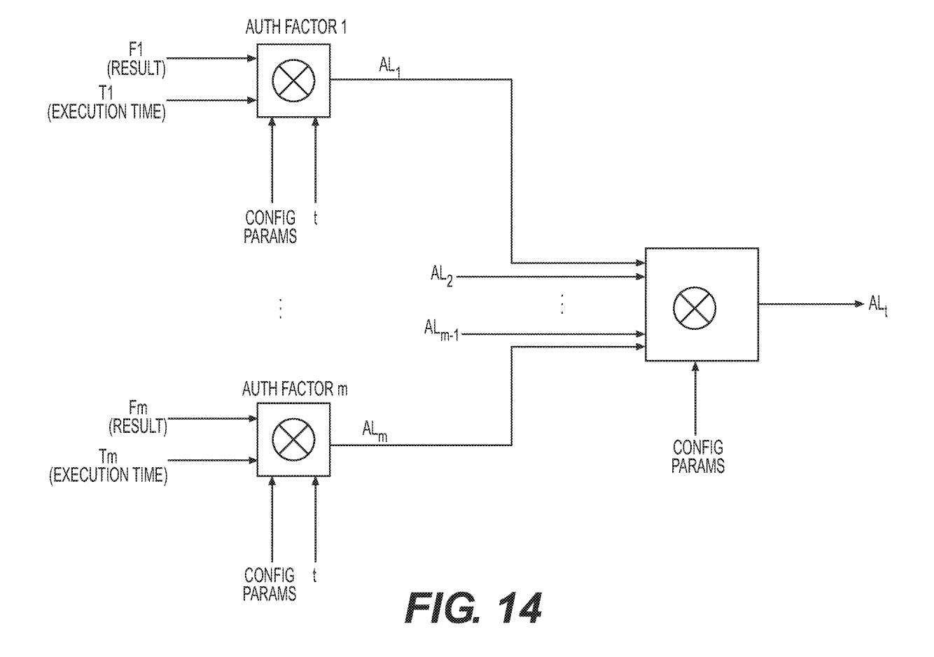

Referring now to FIG. 14, an example diagram of the policy operations for determining assurance level in accordance with an example embodiment is depicted. With respect to the example depicted in FIG. 14: Fm is the success/failure result from the authentication factor “m”; Tm is the execution time, e.g. timestamp of successful authentication of authentication factor “m”; and Configuration parameters are specific to each authentication factor, and may include parameters for device and/or authentication specific weight factor and freshness parameters.

In an example embodiment, each authentication factor has an associated time validity after which a re-authentication may have to be carried out. An Authentication associated with a particular factor is considered to be fresh if at an instance, the validity of the authentication has not expired. The freshness factor may decay over time (linearly, exponentially or a combination thereof). The outcome from applying an authentication factor or factors is binary with the result being either a success or failure. The assurance level related to a user authentication factor(s) is based on the authentication outcome and a freshness factor, which is configurable for each authentication factor.

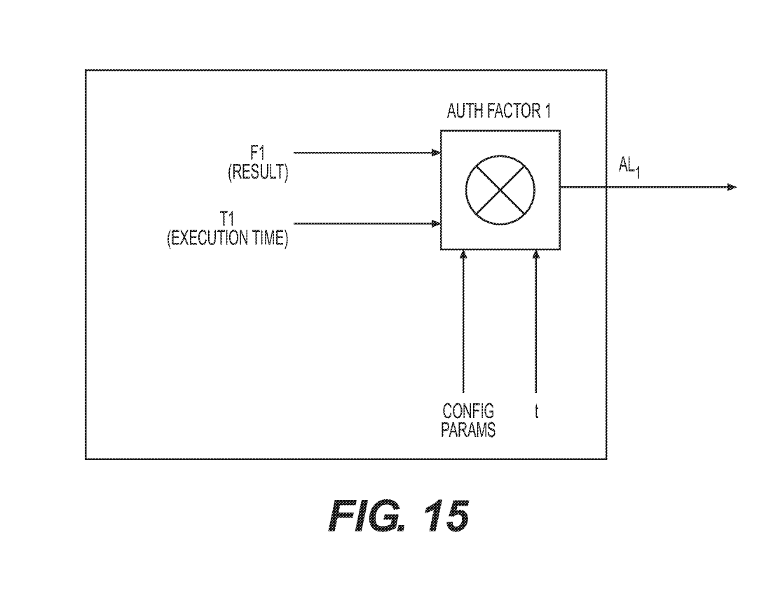

Referring to FIG. 15, although complex implementations of freshness decay are possible, in a simplified illustrative implementation, the determination of freshness of an authentication factor may consider the following example input parameters, presented by way of example and without limitation: Time of last successful authentication (T1); Current time (t); Result of Authentication Factor 1 (F1), which can be binary (e.g., 1 or 0) or, in some cases where the degree of certainty of an authentication lies within a grey area another scale may be used; and decay characteristic for the authentication. Decay characteristics may be related to the freshness of the authentication, and to the initial and final allowed assurance levels for a given authentication factor or combination of authentication factors. For instance, the decay in a supported assurance level might be based upon a decay curve, where the freshness of a factor diminishes over time. In an alternate approach, the freshness may represent on/off function in which the factor is considered valid for a pre-defined period of time after which the authentication is considered stale. Alternatively still, decay may be specified by an exponential decay parameter. The configuration of the freshness decay function may be configured for each authentication factor. For example, each factor may be associated with a decay type that indicates whether the freshness decays, for example, linearly, exponentially, or in accordance with a step function with variables that may be linear or exponential. Each factor may be associated with a freshness time, which may be a value (e.g., millisecond, minutes etc.) during which the factor is considered valid for a certain assurance level for a defined period of time after a successful authentication. The factor is considered “stale” after that specific period or window of time, and thus might need to be re-authenticated. Each factor may also be associated with a decay parameter, which represents the rate of decay over time of the freshness (relevant for an exponential decay function or other measurements).

In some cases, timestamps of when an authentication factor is carried out are determined by the MFAS 102 for authentications that are carried out by the network entities, while the timestamps of when local authentication factors are carried out is determined by the MFAP 106. The configuration of the values that determines freshness associated with each factor may be determined by the MFAS 102 based on device type, authentication (Auth) policies, SP policies, and computation algorithm. The MFAS may specify parameter values for each network and local authentication factor freshness function. The details of the decay and freshness time are detailed below. If freshness for a given authentication factor is configured with a decay factor and type, then the output of authentication (e.g., AL) can be determined depending on the decay function. For example, with respect to an exponential decay function, the freshness decay is represented by the provided parameter (Authentication Factor Freshness Decay Parameter). For a linear decay, the freshness decays from the current level to zero at the time specified by the Authentication Factor Freshness Time. For a step decay, the authentication is valid until the time specified by the Authentication Factor Freshness Time.

By way of further example, if freshness is a step function, then the AL may be determined as follows: If (t−T1)>Freshness Time then AL1=0, the authentication should be refreshed; or If (t−T1)<Freshness Time then AL1=AL. If the freshness is a linear decay then the freshness time may be the time when the authentication decays to zero.

An Authentication Factor Freshness Decay Parameter may be a parameter value representing the rate of decay over time of the freshness for the case of an exponential freshness decay function.

With respect to determining authentication factors to be performed, now described is an example embodiment of a policy management operation performed by the MFAS 102 to determine the set of authentication factors based on the authentication request that is received from the RP 108. In accordance with the example, the MFAS 102 receives an authentication request from a first service provider of a plurality of service providers. The received request may be received via a form redirection from the user device 112. This message may be a response to a user/browser requesting service to the SP 108. A userID may be contained in the request. The MFAS 102 may check one of the databases 114 to determine whether the user ID exists in LDAP. In response to the authentication request, the MFAS 102 may obtain information from at least one database to authenticate the user in accordance with policy information related to the SP 108. For example, the MFAS 102 may retrieve, for instance from the service provider database 114b, and store the AL_{REQ} that was previously received from the RP 108. Alternatively the required AL may be included in the authentication request. If no AL is present in the authentication request, then default values may be used, or previously used values pertaining to the context may be used. The MFAS 102 may send a javascript page to the device browser, in order to check to see if an MFAP is running on the device. If it is, then the MFAP may respond to the MFAS with a device ID (or an MFAP ID) via the javascript page. If the MFAS 102 does not receive a response, in one example, then the MFAS 102 can determine that the end device does not have an MFAP. The MFAS may obtain user profile information from a database (e.g., user database 114a) based on the user ID or the Device ID (MFAP ID). Further, the MFAS 102 may determine applicable policy and authentication based on the user profile information, for example by performing policy operation logic described below.

Continuing the above example, the MFAS 102 determines the policy configuration, which may indicate a prioritized list of runnable authentication factors. Such a determination may be based on the authentication factor information stored in at least one database 114. Based on, for example and without limitation, the user ID, MFAP ID, device information, and RP site URL, the MFAS 102 creates a list of policy operations for each of the authentication factors. The MFAS 102 may then determine the AL_{N} and the AL_{D}. Based on the prioritized list of runnable factors, and based on the freshness associated with each factor, the MFAS 102 may determine if the required AL has been met. If it has been met, the MFAS 102 may return a positive assertion to the RP 108. If has not been met, the MFAS 102 may determine the shortfall of the AL. For example, or each authentication factor in a runnable factor list, the MFAS 102 may remove a freshness AL from the current AL, add a maximum AL if a given authentication factor is successful, and add a list of authentication factors to run. The MFAS 102 may execute network authentication factors on a list of factors to run. The MFAS 102 may also invoke local authentication factors by providing the AL_{D} to the MFAP 106 to determine and run local authentication factors on the device. If key generation is necessary, the MFAS 102 may indicate to the MFAP 106 to run a local password authentication as part of the local authentication factors.

With respect to handling Equivalent Authentication Factors between MFAS and MFAP, in accordance with an example embodiment, based on the available network and local authentication factors, there may be certain factors which the MFAS may regard as one and the same and as such offer no additional assurance level (or very minimal additional assurance level) when run both on the network and locally on the device. For example, password authentication factors may fit into this type of factor. Running a network-based password authentication and a local authentication for the same request, might not offer much in terms of assurance level. Thus, in order to avoid duplicate authentication prompts to the end user, the MFAS 102 may need to know and/or control which authentication factors the MFAP 106 runs based on the required local AL that the MFAP 106 needs to achieve. Similarly, the MFAS 102 may also need to indicate to the MFAP 106 to avoid certain authentication factors that may run on the network side and have attained a certain level of freshness.

In accordance with an example embodiment, he MFAS 102 may control the local authentication factors by providing a policy “guideline” that the MFAP 106 may follow when determining the set of authentication factors to run, based on the AL_{D} that is determined by the MFAP and/or MFAS. As part of the initial default policy configuration for the MFAP 106, the MFAS 102 may configure certain local authentication factors not to be run as part of the policy operation, based on prioritization of all available authentication factors for example. Additionally, the MFAS 102 may configure the MFAP 106 for policy override parameters for certain RPs. In this case, the MFAS 102 may share information regarding the equivalent factor that has been executed from the network side, such as the timestamp (for purpose of determining freshness) and/or results. Based on the freshness of the equivalent factor that was executed on the network side, the MFAP 106 may determine whether the equivalent factor has to be executed locally or not.

In response, the MFAP 106 may provide information to the MFAS 102 regarding the authentication factors that have been executed, along with the achieved assurance level. This may be sent with the assertion or as a separate message for synchronization and logging purposes. For example, the MFAP 106 may send a HTTPS message with detailed authentication results, timestamps, and other information regarding the last local authentication attempt, as detailed herein.

With respect to an example local authentication policy flow from the MFAS 102 to the MFAP 106, in accordance with the example embodiment, the input to the MFAP 106 for local authentication is the AL_{D} requirement received from the MFAS 102. In some cases, he MFAP 106 has pre-provisioned policies, as part of the initial configuration, to help translate the AL_{D} into the specific set of authentication factors to meet the MFAS 102 determined local assurance level (AL_{D}). Alternatively, the set of authentication factors may be explicitly indicated (e.g., by the MFAS 102) in a list or in a predefined enumeration.

From the required assurance level input from the MFAS 102, the MFAP 106 may determine, based on provisioned policies, the set of authentication factors that are needed to satisfy the required AL_{D}.

Based on the set of authentication factors, the MFAP 106 may check the freshness of each authentication factor to determine whether the AL_{D} has been satisfied without re-running the authentication factors. If the AL_{D} has been achieved, then the MFAP 106 may return a positive assurance without running any authentication factors. If, alternatively, the required AL_{D} has not been met, then the MFAP 106 may determine which authentication factors to execute in order to achieve the AL_{D}. The authentication factors as part of the set may be prioritized based on predetermined configuration and policy in the MFAP 106, and as such, based on that priority, the MFAP 106 may determine which authentication factors to run in order to achieve the required AL. Priorities may be based on factors that offer less friction as far as user involvement is concerned.

In some cases, if the executed authentication factors are successful and the AL_{D} has been met as a result, then the MFAP 106 may return a positive assertion to the MFAS 102.

In some cases, if certain authentication factors are not successful and the AL_{D} has not been met, then the MFAP 106 may return a negative assertion or, alternatively, send just an achieved AL value. Alternatively still, if certain authentication factors are not successful and the AL_{D} has not been met, then the MFAP 106 may return a negative assertion and the achieved AL value.

Along with the positive or negative assertion, the MFAP 106 may provide the MFAS 102 with information related to each executed authentication factor. Such information may include parameters such as, for example, time of execution, result of execution, and achieved assurance level.

The MFAP 106 may, upon request from the MFAS 102 for example, also provide log information of any or all local authentication factors that have been executed. Such log information may be used for forensic purposes.

Below is an example pseudocode for the MFAP function to determine authentication factors. It will be understood that the pseudocole below if presented for purposes of example, and functionality of the MFAP may vary as desired.

//MFAP has the following information arrays:
number_of_factors == # of local factors of authentication
factor_assurance_level[ ] == current assurance level of a factor
achievable_assurance_level[ ] == assurance level achievable by a factor
priority_evaluation[ ] == usage priority or preference of a particular factor. e.g.
based on ease of use, fiction, convenience to user etc. highest preference of factor
is at top of list
factor_to_perform[ ] == authentication factor to perform in order to achieve required
assurance level
Then if the requested AL is AL_req, use the following logic.
Current_assurance_level = 0;
for (factor = 0; factor < number_of_factors; factors++) {

factor_to_perform[factor] = 0;

}
for (factor = 0; factor < number_of_factors; factors++) {

Current_assurance_level += factor_assurance_level[priority_evaluation[factor]];

}
if (AL_req < Current_assurance_level)

// done send a signed assertion of current assurance level back

else {

level_of_assurance = Current_assurance_level;
// Determine which factors should be performed to achieve the desired level of
// assurance based on factor priority handling
for (factor = 0; factor < number_of_factors; factors++) {

level_of_assurance −=
factor_assurance_level[priority_evaluation[factor]];
level_of_assurance +=
achievable_assurance_level[priority_evaluation[factor]];
factor_to_perform[factor] = 1;
// If done then exit loop
if (AL_req < level_of_assurance)

break;

}

// Perform the factor authentication as indicated by the factor_to_perform list

for (factor = 0; factor < number_of_factors; factors++) {

If (factor_to_perform[priority_evaluation[factor]] == 1)
// Perform factor priority_evaluation[factor] authentication

}

}

With respect to authentication during a disconnected (e.g., offline) mode, in accordance with an example embodiment, the MFAP 106 may act as a local proxy for the MFAS 102 for other access to local resources, such as user applications that may reside on the user device or network, and data that may require multi-factor authentication on the end-user device. The application may trigger the MFAP 106 for authentication using the locally provisioned policies without connecting to the MFAS 102, for example, because the device does not have a network connection at the time of the authentication request. The MFAP 106 may follow the same or similar process (as the MFAS 102 may follow) to determine authentication factors that are selected for execution. In some cases, however, the MFAP 106 may determine the authentication factors based on only local authentication factors that are available to the user and the device. In some cases, previously run authentication factors (both local and network-based) may be considered (for the authentication) based on their freshness. In an example, once the user device moves from offline to online mode, information regarding local authentication factors that were executed during offline mode may be shared between the MFAP 106 and the MFAS 102 through previously established secure communication channels.

In some cases, when the application/browser 107 on the user device 112 lacks network connectivity or optionally chooses to authenticate locally without connecting to the RP 108, an application on the user device 112 may send an internal procedural call (e.g., an Intent in Android) directly to the MFAP 106 (e.g., with soid.scheme URL) with a required AL value for user authentication. Based on the offline policy information as configured in the MFAP 106, the end user 110 may be authenticated locally.

In an example of offline authentication, as part of initial policy configuration, the MFAP 106 may be provided, by the MFAS 110, with information regarding authentication factors and whether they are to be run when there is no network connection available or when a user would like to use local applications. In the policy information database layout for the MFAP, a “Usable when offline” flag indicates whether a particular local authentication factor may be used when authenticating the end user while the device is offline. In some cases, the configuration of each authentication factor may follow the same policy as when performing authentication online with a network connection, unless a policy override exists for that particular application/site.

In an example case, the MFAS 102 may determine that AL requirements from a given RP may be met using only local authentication factors. In this case, the MFAS 102 may trigger the MFAP 106 to perform the local authentication factors and, rather than return the outcome back to the MFAS 102, may have the MFAP 106 return an OpenID assertion back to the RP directly, thus using smart Open ID functionality in the MFAP 106. For a local application on the user device 112, an assertion may be sent by the MFAP 106 to the local application.

Functionality that may be augmented in the MFAP/MFAS, presented by way of example without limitation, includes MAC key generation. In some cases, MAC key generation for assertion signing must be the same as MFAS (which generates during association with RP). Currently the MAC key is generated in the OP based on PBDFK2 with association handle as salt and a fixed byte array of 0x41 as the password. In the MFAP, PBDFK2 is used with association handle as salt, and long term secret (hardcoded) as password. The MAC key is fixed to 20 byte length which limits the assertion signing to HMAC-SHA1. Note that OpenlD spec recommends the use of SHA256. In an embodiment, a message from the MFAS 102 to the MFAP 106 indicates in soid.scheme URI that SOID is used, and that the MFAP 106 should return the assertion to the RP 108. The MFAS 102 should also indicate whether HMAC-SHA1 or SHA256 should be used for assertion signing. The MFAP 106 may or may not return success/failure outcome back to MFAS 102.

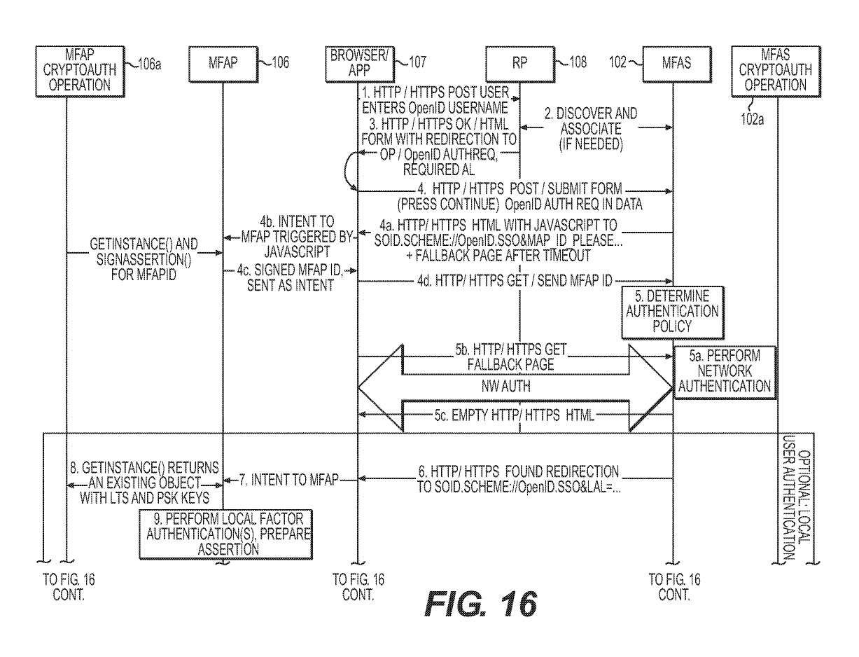

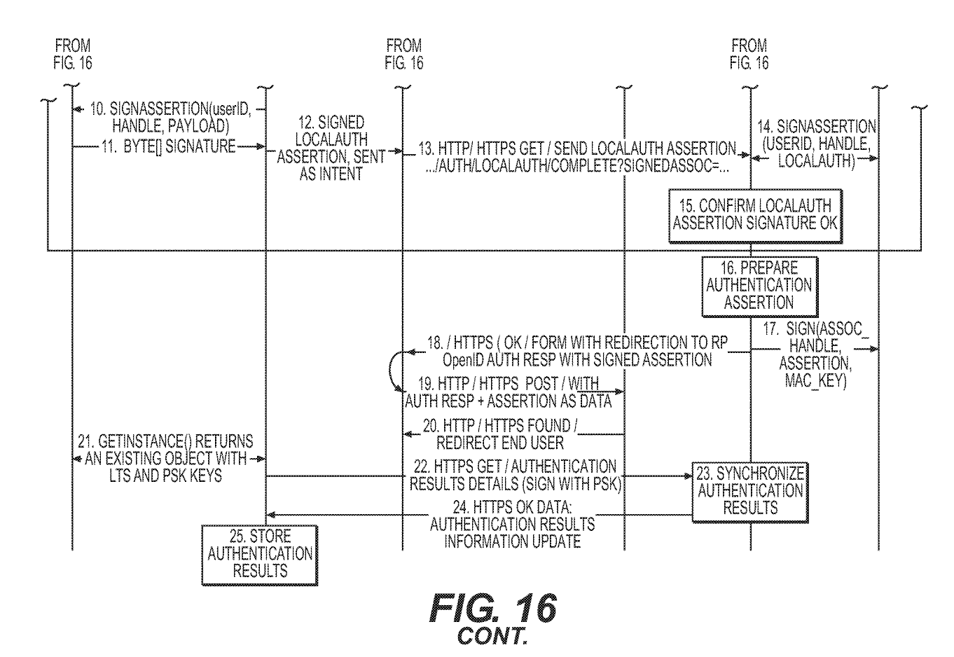

Referring now to FIG. 16, the illustrated call flow is representative of a successful authentication executed by the MFAS 102 and MFAP 106, as requested by the RP 108 for providing a service to the user 110, in accordance with an example embodiment. It will be appreciated that the example system illustrated in FIG. 16 is simplified to facilitate description of the disclosed subject matter and is not intended to limit the scope of this disclosure. Other devices, systems, and configurations may be used to implement the embodiments disclosed herein in addition to, or instead of, a system such as the illustrated system, and all such embodiments are contemplated as within the scope of the present disclosure.

As a prerequisite to the illustrated authentication flow, the MFAS 102 and MFAP 106 may perform a configuration process to exchange information, so that the MFAS 102 may construct and provide the MFAP 106 with authentication policy information for a subsequent authentication of a user on the device 112. Referring to FIG. 16, in accordance with the illustrated embodiment, at 1, the user 110 requests access to a service provided by the RP 108. In accordance with the example, the user 110 uses an Open ID identity for logging in to the service via the browser 107. At 2, the RP 108 discovers and optionally associates with the OpenID IdP (OP), which may be the MFAS 102, as identified in the Open ID identity and using mechanisms described by the OpenlD specifications. At 3, in accordance with the illustrated example, an authentication request is sent from the RP 102 to the end user with redirection to the MFAS 102. The RP 108 may provide the required AL (ALREQ) in this message. At 4, he end user, in particular the browser 107, redirects the authentication request to the MFAS 102. The MFAS 102 may query the user for a unique identity (e.g., MFAP ID), which may be provided by the end user device 110 if the MFAP 106 is running on the device 110. For example, at 4a, the MFAS 102 provides an HTTP message with javascript to the device 110, which provides a trigger (e.g., an Intent in Android) to the MFAP 106 (when the MFAP exists on the device). At 4b, if the MFAP 106 is running, it receives the trigger to provide its unique identifier, and signs the identifier with a nonce and previously generated key. A cryptographic operation 106a of the MFAP 106 may sign the assertion. At 4c, the MFAP 106 provides the unique identifier and signed assertion back to the browser, for instance as an Android Intent. At 4d, the device 110 provides the identifier back to the MFAS 102, via the browser 107. In some cases, if an MFAP does not exist on the device, the above procedures may timeout and the MFAS 102 is informed that an MFAP is not running on the end user device.

Still referring to FIG. 16, in accordance with the illustrated embodiment, at 5, the MFAS 102, based on the required AL (ALREQ) and available authentication factors for the end user/MFAP (which are based on the MFAP ID), determines the combination of local and network based authentication factors that have to be carried out. In some cases, it may be preferable for the network authentication factors to be carried out first. At 5b, the browser 107 times out and is directed to a fallback server page. If the MFAP ID is not provided in step 4d, step 5a may be performed with the “default factor.” As a response to this step, step 5c is not performed in accordance with one example. If the MFAP ID was provided in step 4d, step 5c is performed to finish the HTTP exchange, while step 5a may occur in parallel. As shown, an empty http message is sent at 5c. At 6, the MFAS 102 may optionally provide the MFAP 106 with a message to initiate the local authentication factors. The local authentication factors to be performed are indicated in a predefined value, for instance a Local Assurance Level (LAL) or AL_{D} specified explicitly in a string. At 7, in accordance with the illustrated example, the browser 107 receives an HTTP redirect message, and redirects the HTTP message as an intent (Android intent) to the MFAP 106, in order to trigger the MFAP application to initiate Local Authentication Factors. At 8, the MFAP 106 may check its cryptographic function 106a for a set of predetermined keys for purposes of assertion signing. At 9, the MFAP 106 performs a freshness check for specified local authentication factors and determines whether the authentication needs to be performed or that freshness is sufficient. The MFAP 106 performs the necessary authentication factors that is required to meet or exceed the AL that was requested by the MFAS 102.

With continuing reference to FIG. 16, at 10, the MFAP 106 uses the cryptographic operation or function 106a to sign the assertion of the result of the set of local authentication factors. At 11, the cryptographic function 106a returns a signature to the MFAP 106. At 12, the MFAP 106 receives the outcome of the authentication factors, and sends a signed assertion back to the browser 107 as Intent. At 13, the browser 107 sends the HTTP message with an assertion for positive or negative outcome to the MFAS 102. At 14, the MFAS 102 uses its cryptographic authentication operation or cryptographic function 102a to generate the assertion based on the same message and handle as the MFAP 106. At 15, the MFAS 102 matches and confirms the validity of the assertion that was provided by the MFAP 106 and generated by the cryptographic function 106a. At 16, in accordance with the illustrated example, the MFAS 102 generates the OpenID authentication response based on the outcome of the executed network and local authentications. At 17, the MFAS 102 generates the assertion for the message back to the RP 108 using the previously defined association handle and MAC key. At 18, the MFAS 102, via redirect through the end user browser 107, provides the signed assertion to the RP 108. In some cases, the authenticated assurance level may be included in the message. This step can also be a soid.scheme custom URI redirection encoded with authentication response, which triggers step 22 as well as the redirection to the RP 108 with the authentication response. At 19, if the assurance level requested by the RP 108 was achieved and the signature of the message is verified, access to the service requested by the user 110 is provided by the RP 108. At 20, in accordance with the illustrated example, the RP 108, based on a successful outcome of the authentication, redirects the end user. At 21, in order to synchronize authentication factor results between the MFAS 102 and the MFAP 106, a signed message is generated, based on the results log, by the cryptographic function 106a. At 22, the results log of the authentication factor is provided by the MFAP 106 to the MFAS 102 via HTTPS. At 23, the MFAS 102 stores the local authentication factor results to one or more databases 114. At 24, the MFAS 102 responds to the MFAP 106 via HTTPS with a results log of network-based authentication factors. At 25, the MFAP 106 stores the network-based authentication factor results into at least one database 115.

Turning again to phase 3 (synchronization of authentication results and policies), in accordance with an example embodiment, after completion of local authentication factors by the MFAP 106, and after the assertion has been sent back to the MFAS 102 (via the browser 107), the MFAP 106 and MFAS 102 may run an additional procedure to collect detailed authentication factor results and provide any policy configuration updates for the MFAP 106. This refers to steps 22 to 24 in FIG. 16 described above. Similar to the initial configuration, this interaction may take place with HTTP over TLS (e.g., HTTPS) directly between the MFAS 102 and MFAP 106. By way of example, this procedure may be triggered from the MFAS 102 to the MFAP 106 (via the browser), or it may occur after each and every local authentication factor execution. Alternatively, by way of further example, a policy at the local device 112 may trigger the MFAP 106 to report local authentication results periodically. Similarly, results of authentications that were carried out on the network (or network-assisted factor authentications) may be provided by the MFAS 102 to the MFAP 106 periodically, for instance during the synchronization procedure. Other mechanisms may trigger the MFAP 106 to setup a HTTP connection with the MFAS 102 (e.g., SMS-based triggers). Push mechanisms from the MFAS 102 may also be used to provide log and report information. By way of example and without limitation, the results may include various information such as a timestamp, a result, and an assurance level. The timestamp may indicate the time when the authentication was last executed. The result may indicate whether the previous authentication attempt was successful or was a failure. The assurance level may indicate the assurance (e.g., strength) of the authentication factor.

In addition, a cumulative AL may be provided. The MFAP 106 may send the cumulative AL via an HTTP GET (HTTPS) message. The message may also include information described above in the query part of the URI.

In an example embodiment, the MFAS 102 may store the information received from the MFAP 106 in one or more of its databases 114. The information may be stored to keep a recorded log for each user. The information may also be stored to update the system log to reflect any local authentication attempts. In response to the information, the MFAS 102 may also send an update to the MFAP 106. The update may include an updated set of policy configurations for a specific RP site. The MFAS 102 may also provide, to the MFAP 106, authentication results associated with network authentication factors. By way of example, and without limitation, the following information may be provided from the MFAS 102 to the MFAP 106: an RP site specific policy configuration override; results information for an equivalent network authentication factor result; and network authentication factor results information. The RP site specific policy configuration override may include parameters that override the default configuration policy that is defined in the initial configuration for a given RP. With respect to equivalent network authentication factor results information, the MFAS 102 may provide information associated with network authentication factor results (e.g. result, timestamp) for factors that have an equivalent local factor configured on the end user device. With respect to network authentication factor results information, the MFAS 102 may also provide information regarding all authentication factors that have been executed on the network side. The MFAS 102 may store these results in the at least one of the databases 114 as system logs.

FIG. 17A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 17A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 17A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 17A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 17A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 17A may be configured to communicate with the base station 64a, which may employ a cellular-based radio technology, and with the base station 64b, which may employ an IEEE 802 radio technology.

FIG. 17B is a system diagram of a node, such as a node that is implemented in FIGS. 1 to 16, for instance the MFAS 102 or user device 112. As shown in FIG. 17B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 17B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 17B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 68 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 68 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 17C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 17C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 17C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 56 shown in FIG. 17C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, network server, or any host computer.

1. A method performed by an authentication server, the method comprising:
maintaining at least one database, such that the at least one database comprises user profile information related to a plurality of users, authentication information related to a plurality of user devices, and policy information related to a plurality of service providers;
receiving an authentication request from a first service provider of the plurality of service providers;
in response to the authentication request, obtaining information from the at least one database to authenticate a first user of the plurality of users in accordance with the policy information related to the first service provider, and profile information related to the first user, wherein the authentication request or the policy information indicates an assurance level required by the first service provider such that the first user is authenticated to an assurance level that is sufficient as compared to the assurance level required by the first service provider;
separating the assurance level required by the first service provider into a local assurance level and a network assurance level; and
sending the local assurance level to a multi-factor authentication proxy on a user device.

2-4. (canceled)

5. The method as recited in claim 1, wherein the authentication request indicates at least one user device that the first user is using to access a service provided by the first service provider.

6. The method as recited in claim 1, wherein the at least one database comprises a user database for maintaining the user profile information related to the plurality of users, a user equipment database for maintaining the authentication information related to the plurality of user devices, and a service provider database for maintaining the policy information related to the plurality of service providers.

7. The method as recited in claim 1, the method further comprising:
determining, based on the user profile information, a device possessed by the first user, wherein the device is associated with the authentication request.

8. The method as recited in claim 7, the method further comprising:
determining, based on the device possessed by the first user, at least one authentication factor that can be used to authenticate the first user.

9. The method as recited in claim 1, the method further comprising:
determining, based on policy information related to the first service provider, at least one authentication factor that is acceptable to the first service provider.

10. The method as recited in 7, the method further comprising:
based policy information related to the first service provider that is specific to the device possessed by the first user, determining at least one authentication factor that is acceptable to the first service provider.

11. The method as recited in claim 1, the method further comprising:
determining one or more combinations of one or more authentication factors that meet the assurance level required by the first service provider.

12. The method as recited in claim 11, the method further comprising:
asserting a result associated with one of the one or more combinations, such that the first user can access a service provided by the first service provider.

13. The method as recited in claim 11, the method further comprising:
determining a priority associated with each of the one or more authentication factors.

14. The method as recited in claim 6, the method further comprising:
accessing the user database to determine authentication capabilities of the first user.

15. The method as recited in claim 6, the method further comprising:
accessing the user equipment database to determine authentication capabilities of the user device of the first user.

16. The method as recited claim 6, the method further comprising:
accessing the service provider database to determine the assurance level required by the first service provider.

17. The method as recited in claim 6, the method further comprising:
accessing the service provider database to determine attributes related to the one or more authentication factors that meet the assurance level required by the first service provider.

18. The method as recited in claim 11, the method further comprising:
accessing an authentication factor database to determine a plurality of authentication attributes associated with each of the authentication factors, the attributes including at least one of a freshness, an assurance level, a priority, and a retry limit.

19. An entity comprising communication circuitry such that the entity is communicatively coupled with a plurality of service providers via its communication circuitry, wherein the entity further comprises:
a processor and a memory, the memory containing computer-executable instructions that when executed by the processor, cause the processor to perform operations comprising:
maintaining at least one database, such that the at least one database comprises user profile information related to a plurality of users, authentication information related to a plurality of user devices, and policy information related to a plurality of service providers;
receiving an authentication request from a first service provider of the plurality of service providers; and
in response to the authentication request, obtaining information from the at least one database to authenticate a first user of the plurality of users in accordance with the policy information related to the first service provider, and profile information related to the first user, wherein the authentication request or the policy information indicates an assurance level required by the first service provider such that the first user is authenticated to an assurance level that is sufficient as compared to the assurance level required by the first service provider;
separating the assurance level required by the first service provider into a local assurance level and a network assurance level; and
sending the local assurance level to a multi-factor authentication proxy on a user device.

20-22. (canceled)

23. The entity as recited in claim 19, wherein the authentication request indicates at least one user device that the first user is using to access a service provided by the first service provider.

24. The entity as recited in claim 19, wherein the at least one database comprises a user database for maintaining the user profile information related to the plurality of users, a user equipment database for maintaining the authentication information related to the plurality of user devices, and a service provider database for maintaining the policy information related to the plurality of service providers.

25. The entity as recited in claim 19, the operations further comprising:
determining, based on the user profile information, a device possessed by the first user, wherein the device is associated with the authentication request.

26. The entity as recited in claim 25, the operations further comprising:
determining, based on the device possessed by the first user, at least one authentication factor that can be used to authenticate the first user.

27. The entity as recited in claim 19, the operations further comprising:
determining, based on policy information related to the first service provider, at least one authentication factor that is acceptable to the first service provider.

28. The entity as recited claim 25, the operations further comprising:
based policy information related to the first service provider that is specific to the device possessed by the first user, determining at least one authentication factor that is acceptable to the first service provider.

29. The entity as recited in claim 19, the operations further comprising:
determining one or more combinations of one or more authentication factors that meet the assurance level required by the first service provider.

30. The entity as recited claim 29, the operations further comprising:
asserting a result associated with one of the one or more combinations, such that the first user can access a service provided by the first service provider.

31. The entity as recited in claim 29, the operations further comprising:
determining a priority associated with each of the one or more authentication factors.

32. The entity as recited in claim 24, the operations further comprising:
accessing the user database to determine authentication capabilities of the first user.

33. The entity as recited in claim 24, the operations further comprising:
accessing the user equipment database to determine authentication capabilities of the user device of the first user.

34. The entity as recited claim 24, the operations further comprising:
accessing the service provider database to determine the assurance level required by the first service provider.

35. The entity as recited in claim 24, the operations further comprising:
accessing the service provider database to determine attributes related to the one or more authentication factors that meet the assurance level required by the first service provider.

36. The entity as recited in claim 29, the operations further comprising:
accessing an authentication factor database to determine a plurality of authentication attributes associated with each of the authentication factors, the attributes including at least one of a freshness, an assurance level, a priority, and a retry limit.
